(19) United States
(12) Patent Application Publication
(10) Pub. No.: US 2017/0206554 A1
(43) Pub. Date: Jul. 20, 2017

(54) CENTRALIZED SYSTEM OF AGGREGATED DATA SOURCES AND METHODS OF USE

(71) Applicant: Mack Craft, St. Augustine, FL (US)

(72) Inventor: Mack Craft, St. Augustine, FL (US)

(21) Appl. No.: 15/472,246

(22) Filed: Mar. 28, 2017

Related U.S. Application Data
(63) Continuation-in-part of application No. 15/138,194, filed on Apr. 25, 2016.
Application No. 15/138,194 is a continuation-in-part of application No. 14/973,702, filed on Dec. 17, 2015.
Application No. 14/973,702 is a continuation-in-part of application No. 14/334,592, filed on Jul. 17, 2014.
Application No. 14/334,592 is a continuation-in-part of application No. 14/058,119, filed on Oct. 18, 2013, now abandoned.
(60) Provisional application No. 61/795,497, filed on Oct. 18, 2012.

(51) Int. Cl. G06Q 30/02

(52) U.S. Cl. CPC G06Q 30/0255

(57) ABSTRACT

A system and a method provide information to a user from one of a plurality of different sources. A user can initiate a command or directive requesting information from the system. The system can first determine if information related to the directive is available, and if the information is available, the system can send the information to the user. If information is not available, the system can continuously check one or more different sources for the information requested in the directive. When the system finds or receives the information, the system can send the information to the user.

### CROSS-REFERENCE TO RELATED APPLICATION

This application is a continuation-in-part of U.S. Non-provisional application Ser. No. 15/138,194 filed Apr. 25, 2016, which is a continuation-in-part of pending U.S. Non-provisional application Ser. No. 14/973,702 filed Dec. 17, 2015, which is a continuation-in-part of pending U.S. Non-provisional application Ser. No. 14/334,592 filed Jul. 17, 2014, which is a continuation-in-part of U.S. Non-provisional application Ser. No. 14/058,119 filed Oct. 18, 2013, which claims the benefit of U.S. Provisional Application No. 61/795,497 filed on Oct. 18, 2012, the entire contents of which are incorporated herein by this reference and made a part hereof.

### BACKGROUND

A problem with marketing, whether it involves a conventional advertisement, a coupon, a discount code, or some other form of marketing, is that it often reaches individuals and businesses that are not interested in the promoted business, product or service, and may fail to reach those who are truly interested. Thus, a business pays for broad distribution of an advertisement through print or electronic sources to many consumers, including many who may not be receptive to the advertisement. By way of example a business may publish coupons in a newspaper or other printed publication. Many of those coupons will not reach interested consumers. Many of those coupons will reach consumers lacking interest in the subject matter. While online coupon delivery systems have been devised, such systems are relegated to coupon delivery and still require a consumer to request specific coupons.

Online advertising uses the Internet to deliver promotional marketing messages to consumers. It includes email marketing, search engine marketing, social media marketing, many types of display advertising (including web banner advertising). Like other advertising media, online advertising frequently reaches consumers who are not interested in the content and fails to reach those who may be truly interested.

Online advertisers (typically through their ad servers) often use cookies, which are unique identifiers of specific computers, to decide which ads to serve to a particular consumer. Cookies can track whether a user left a page without buying anything, so the advertiser can later retarget the user with ads from the site the user visited. As advertisers collect data across multiple external websites about a user's online activity, they can create a detailed picture of the user's interests to deliver even more targeted advertising. Often the picture is inaccurate. This aggregation of data is called behavioral targeting. Online advertisers can also target their audience by using contextual and semantic advertising to deliver display ads related to the content of the web page where the ads appear. Re-targeting, behavioral targeting, and contextual advertising all are designed to increase an advertiser's return on investment, or ROI, over untargeted ads.

A problem with such online advertising is that it assumes, often erroneously, that a consumer's web search or a visit to a site or clicking of a hyperlink means that the consumer is interested in the subject matter. This is not always the case. Often, individuals visit online sites and select links inadvertently, mistakenly or indiscriminately, without an interest in the underlying subject matter. Occasionally, a consumer's interest may be transient. By way of example, after a consumer completes the purchase of a new home, that consumer may no longer be interested in home inspection services, notwithstanding prior web searches and online visits to websites promoting such services. In such a case, advertising dollars are squandered and the consumer is alienated if targeted banner ads continue to promote home inspection services to the consumer.

A related problem is unsolicited commercial email, often referred to as SPAM. Such email is often sent indiscriminately to all users on a list, regardless of their interests. Not only does such email consume storage and bandwidth, but it infuriates many consumers. Concomitantly, many email applications do a good job at identifying such email as SPAM and move them to a junk folder or delete them upon receipt. Thus, a consumer may never even see such email.

Other problems are an inability of consumers to aggregate their demands to encourage suppliers to offer particular goods and/or services, or discounts or other savings. Today, consumers lack tools to structure aggregated bids or requests to present to suppliers. Likewise, suppliers lack tools to structure an offering to an aggregate of consumers who have expressed interest. Similarly, such tools are unavailable to assist owners of physical objects that are sensed and monitored via the Internet as part of the Internet of Things (IoT) to aggregate their needs for supplies and services.

Still other problems are an inability to track opportunities, such as opportunities to participate in offerings of goods and services, including sales, opportunities to attend events, opportunities to watch programs or live performances, opportunities to unite with other consumers in requesting a sale or particular goods or services. In the past, emails have been used to communicate sales or events to subscribers. If an email is not read carefully, or overlooked or set aside as SPAM, the email is ineffectual. Even if an email is actually accessed, a user may fail to read it carefully in its entirety, overlooking important time sensitive information. This is particularly true for any emails read by mobile device, and even more particularly true if the email is lengthy or contains multimedia objects.

Other problems include the inability to request information and be provided with the information, assuming the information is not currently available, when the information is first made publicly available.

The invention is directed to overcoming one or more of the problems and solving one or more of the needs as set forth above.

### SUMMARY OF THE INVENTION

To solve one or more of the problems set forth above, in a particular embodiment, a method for presenting information to a user on a user device is provided. A system according to the embodiment includes a central computer system; a database that is accessible by the central computer system and stores a plurality of marketing objects; at least one data feed that is connected to the central computer system and populates the database with a first set of the plurality of marketing objects; at least one portal having a portal database that is accessible by the central computer system and includes a second set of the plurality of marketing objects; at least one synchronizing database that includes a third set of the plurality of marketing objects and synchronizes the third set of marketing objects with the database; and at least one crawler adapted to populate the database with data to generate one more marketing objects. Each of the plurality of marketing objects includes a marketing subject matter. The central computer system receives a first user directive that includes a user identification and a user subject matter. A user may input the first user directive using any input means including voice command. The central computer system determines if the user subject matter matches with the marketing subject matter from one of the plurality of marketing objects. If one of the marketing subject matters matches with the user subject matter, the central computer system sends the matching marketing object to a user device and the user device displays a graphical representation of the marketing object on a display of the user device. If none of the marketing subject matters match with the user subject matter, the central computer system checks the data feed, portal, synchronized database and data retrieved by the crawler for data related to the user subject matter. Upon finding data related to the user subject matter the system creates a marketing object including data related to the user subject matter and sends the created marketing object to the user device. By way of example, the plurality of marketing objects include subject matter related to entertainment, such as data regarding musicians, actors, actresses, athletes, sporting events, bands, music artists, comedians, and entertainers. The computer system may repeatedly check data from the one or more data feeds, the one or more portals, the synchronized database, and the crawler until data related to the user subject matter has been found. The user directive may includes one or more instructions to perform an action based on the user device receiving the matching marketing object. The user device may be adapted to perform the one or more actions when the user device receives the matching marketing object from the computer system.

In another embodiment, a method for obtaining data entails receiving a user directive that includes a unique user identifier, a user subject matter, and an action. A determination is made if one of a plurality of available marketing objects matches with the user subject matter from a marketing object database. If one of the plurality of available marketing objects matches with the user subject matter, the matching marketing object is sent to the user. If none of the plurality of available marketing objects matches with the user subject matter, the following are checked: a plurality of data feeds for data related to the user subject matter; data accessible via one or more portals for data related to the user subject matter; data from a synchronized database for data related to the user subject matter; and data retrieved by a web crawler not stored in the marketing object database for data related to the user subject matter. If data related to the user subject matter is found, a marketing object, including data related to the user subject matter, is created and sent to the user, and to each user having generated a directive with a subject matter related to the created marketing object. The action may be performed based on matching a marketing object with the user subject matter. As an example, the action may include calendaring the marketing object in a calendar of the user, or downloading content (e.g., a movie) based on the matched marketing object to a device of the user, or providing a retail location selling a product related to the matched marketing object. The computer system may repeatedly check data from the one or more data feeds, the one or more portals, the synchronized database, and the web crawler until data related to the user subject matter has been found. By way of example, the plurality of data feeds may be from a first set of retailers, and the one or more portals may be from a second set of retailers, and the synchronized database may be from a third set of retailers.

In another embodiment, a system for obtaining data includes at least one processor; at least one computer-readable storage media having stored thereon computer-executable instructions that, when executed by the at least one processor, causes the system to perform a method. The method entails receiving a user directive that includes a unique user identifier, a user subject matter, and an action. A determination is made if one of a plurality of available marketing objects matches with the user subject matter from a marketing object database. If one of the plurality of available marketing objects matches with the user subject matter, the matching marketing object is sent to the user. If none of the plurality of available marketing objects matches with the user subject matter, the following are checked: a plurality of data feeds for data related to the user subject matter; data accessible via one or more portals for data related to the user subject matter; data from a synchronized database for data related to the user subject matter; and data retrieved by a web crawler not stored in the marketing object database for data related to the user subject matter. If data related to the user subject matter is found, a marketing object, including data related to the user subject matter, is created and sent to the user, and to each user having generated a directive with a subject matter related to the created marketing object. The action may be performed based on matching a marketing object with the user subject matter. As an example, the action may include calendaring the marketing object in a calendar of the user, or downloading content (e.g., a movie) based on the matched marketing object to a device of the user, or providing a retail location selling a product related to the matched marketing object. The computer system may repeatedly check data from the one or more data feeds, the one or more portals, the synchronized database, and the web crawler until data related to the user subject matter has been found. By way of example, the plurality of data feeds may be from a first set of retailers, and the one or more portals may be from a second set of retailers, and the synchronized database may be from a third set of retailers.

### BRIEF DESCRIPTION OF THE DRAWINGS

FIG. 1 is a high level block diagram illustrating components of an exemplary system according to principles of the invention.

FIG. 2 is a high level flowchart of an exemplary method of creating a directive according to principles of the invention.

FIG. 3 is a high level flowchart of an exemplary method of creating another directive according to principles of the invention.

FIG. 4 is a high level flowchart of an exemplary method of matching directives according to principles of the invention.

FIG. 5 is a high level flowchart of an exemplary method of communicating matches to user(s) according to principles of the invention.

FIG. 6 is a high level block diagram of components of an exemplary mobile device for use with an exemplary system and method according to principles of the invention.

FIG. 7 is a high level block diagram of software modules of an exemplary system according to principles of the invention.

FIG. 8 is a perspective view of an exemplary mobile device for use with an exemplary system according to principles of the invention.

FIG. 9 is a high level schematic illustrating data associations for a database for an exemplary system according to principles of the invention.

FIG. 10 is a high level flowchart illustrating steps of requesting and obtaining notifications of the occurrence of one or more specified conditions relating to displayed subject matter according to principles of the invention.

FIG. 11A is a high level block diagram of a system according to principles of the invention.

FIG. 11B is a high level block diagram of a system according to principles of the invention.

FIG. 12 is a plan view of an exemplary calendar display according to principles of the invention.

### DETAILED DESCRIPTION

Embodiments of the present invention include a system and a method for providing information to a user from one of a plurality of different sources based on a user command or directive. Typically, a user can initiate a command or directive requesting information from the system. The system can first determine if information related to the directive is available, and if the information is available, the system can send the information to the user. If information is not available, the system can continuously check one or more different sources for the information requested in the directive. When the system finds or receives the information, the system can send the information to the user.

Embodiments of the present invention can further include a computer network enabled calendaring method. The calendaring method can operate using a computer system with one or more computers and network (e.g., Internet) connectivity. The computer system can receive via the network, a first directive. The first directive can include first directive data, which may include a first subject matter and a first user identification. The first subject matter can express a first interest. By way of example, a user may create a directive expressing interest in a performer, or a brand, or a retailer, or a television program, or a product or a service or something else. The computer system may enter the first directive data in at least one database on the computer system. In some instances, the computer system may calendar an event based on the first directive.

The computer system can receive, via the computer network, a second directive, which includes second directive data. The second directive data typically includes a second subject matter responsive to the first interest and a second time associated with the second subject matter. The computer system determines if the second directive includes second subject matter responsive to the first interest. The computer system enters the second directive data in a database on the computer system. Illustratively, the second directive may offer to sell tickets to a performance, or offer goods of a particular brand, or provide information about a sale at a retailer, or provide information about a television program, or offer a particular product or service or something else in response to the first directive.

The computer system adds a first event to first calendar data for a first calendar associated with the first user identification. The first event identifies the second subject matter and includes the second time. The addition is accomplished by sending the data for the event to the address for the calendar application in accordance with an API for the calendar application. Thus, for example, the first user's calendar data is updated with a new event for the second directive.

The first directive may be provided in a number of ways. For example, the first directive may be input by a first user via the computer network or generated from information input by a first user via the computer network, or the first directive may be generated from a message provided by equipment, via the Internet of Things (IoT). The content of such a message identifies the equipment (e.g., via a unique identifier) and contains data (e.g., a code) that defines the reason for the message (e.g., a code for a low toner warning for a printer).

The first directive may be made available to a plurality of other users. For example, the first directive or data or a link for the first directive may be shared with (e.g., emailed or texted [SMS] to) other users or published (e.g., displayed online) for viewing by other users. Such other users may become associated with the first directive by joining the first directive. Joining entails expressing assent, which may be accomplished with a control, which when selected associates the identifier for the selecting user with the directive. In this manner a plurality of users may join the directive. Such a plurality of users is referred to herein as a consumer group. The calendars of all members of the consumer group may be updated with the first event and each subsequent event relating to the directive.

Illustratively, many users may share the interest in a performer, or a brand, or a retailer, or a television program, or a product or a service or something else expressed in a first directive. By joining the first directive, the users aggregate their demand. The aggregation may appeal to potential providers and may warrant action that a single user's interest could not, in and of itself, compel.

A provider may react to the first directive in any number of ways. The provider may ignore it and not participate. The provider may assent to it in the second directive, in which the provider expresses its intent to fulfill or satisfy the interest set forth in the first directive. Illustratively, the second directive may offer to sell tickets to a performance, or offer goods of a particular brand, or provide information about a sale at a retailer, or provide information about a television program, or offer a particular product or service or something else in response to the first directive. The assent may be conditional or unconditional. An unconditional assent offers fulfillment of the interest as set forth in the first directive. A conditional assent offers fulfillment subject to certain additional or different terms. Additionally, a provider may propose, in the second directive, an alternative to the interest expressed in the first directive.

Illustratively, if a first directive calls for a particular brand and model number of toner cartridge, the second directive may offer the requested brand and model number, or may offer an alternative brand and model number that fits the same printers, or may offer something different such as a high capacity model of the toner cartridge, or may offer any combination of the foregoing.

While a user may create a directive, that is but one way of directive creation. Directives may be created by the computer system in response to determined interests. For example, a directive may be created by the computer system in response to a message received from equipment, i.e., equipment that has previously been registered with the system. Registration associates an identification for the equipment with an identification for the user. Thus, the system associates the equipment with the user. Such association may be accomplished through a directive. For instance, a first user may produce a first directive including first directive data, with a first subject matter and a first user identification, wherein the first subject matter includes a first equipment identification. The computer system enters the first directive data in at least one database on the computer system and associates the first directive data with the first user identification. Subsequently, the computer system may receive, via the computer network, a first message from the first equipment. The first message may include the first equipment identification and a first message content. By way of example, the first message content indicating a need for one of a product and service. In response, the computer system may create a second directive, including the first user identification, the first equipment identification, the first message content and a time. The computer system may then add a first event to first calendar data for a first calendar associated with the first user identification. The first event may identify the second subject matter and include the second time. The computer system may enter the second directive data in at least one database on the computer system.

Subsequently, the computer system may receive, via the computer network, a third directive. The third directive may include third directive data, with a third subject matter responsive to the first message content of the second directive, and a third time associated with the third subject matter. The computer system determines if the third directive includes third subject matter responsive to the first message content of the second directive. The computer system enters the third directive data in at least one database on the computer system. The computer system adds a second event to the first calendar data for the first calendar associated with the first user identification. The second event identifies the third subject matter and includes the third time.

The first message may be provided in a number of ways. The first message being forwarded to the system by a first user via the computer network. It may be communicated directly from the equipment to the computer system, via the Internet. The message may be a copy of a message produced by the equipment or the original message produced by the equipment.

The computer system may aggregate demand by associating the second directive with a plurality of users, such as a first user, a third user and a fourth user. Users may join the directive by entering a join command (e.g., by selecting a join control), as described above. The computer system may then add the first event to third calendar data for a third calendar for the third user and to fourth calendar data for a fourth calendar for the fourth user.

A provider may react to the second directive in any number of ways. The provider may ignore it and not participate. The provider may assent to it in the third directive, in which the provider expresses its intent to fulfill or satisfy the interest set forth in the second directive. Illustratively, the third directive may offer to sell tickets to a performance, or offer goods of a particular brand, or provide information about a sale at a retailer, or provide information about a television program, or offer a particular product or service or something else in response to the second directive. The assent may be conditional or unconditional. An unconditional assent offers fulfillment of the interest as set forth in the second directive. A conditional assent offers fulfillment subject to certain additional or different terms. Additionally, a provider may propose, in the second directive, an alternative to the interest expressed in the second directive.

In another implementation, an aggregate directive is generated by receiving, on a computer system, via a computer network, a first directive, the first directive including first directive data. The first directive data includes a first subject matter and a first user identification. The first subject matter expresses a first interest. The computer system enters the first directive data in at least one database on the computer system. The computer system provides the first directive data to a plurality of users, including a third user and a fourth user. The computer system associates the first directive with the plurality of users, including a first user, the third user and the fourth user. The first user is associated with the first user identification. The third user is associated with a third user identification. The fourth user is associated with a fourth user identification. Thus, the first, third and fourth users comprise a consumer group, each associated with the first directive, which is now an aggregate directive that aggregates the demands of the associated users.

The computer system may receive, via the computer network, a second directive, which includes second directive data with a second subject matter responsive to the first interest and a second time associated with the second subject matter. The computer system determines if the second directive includes second subject matter responsive to the first interest. The computer system enters the second directive data in at least one database on the computer system. The computer system then communicates the second directive data to the plurality of users via the computer network. The second directive data may include an assent, a conditional assent, or a counter-proposal.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

### Directives

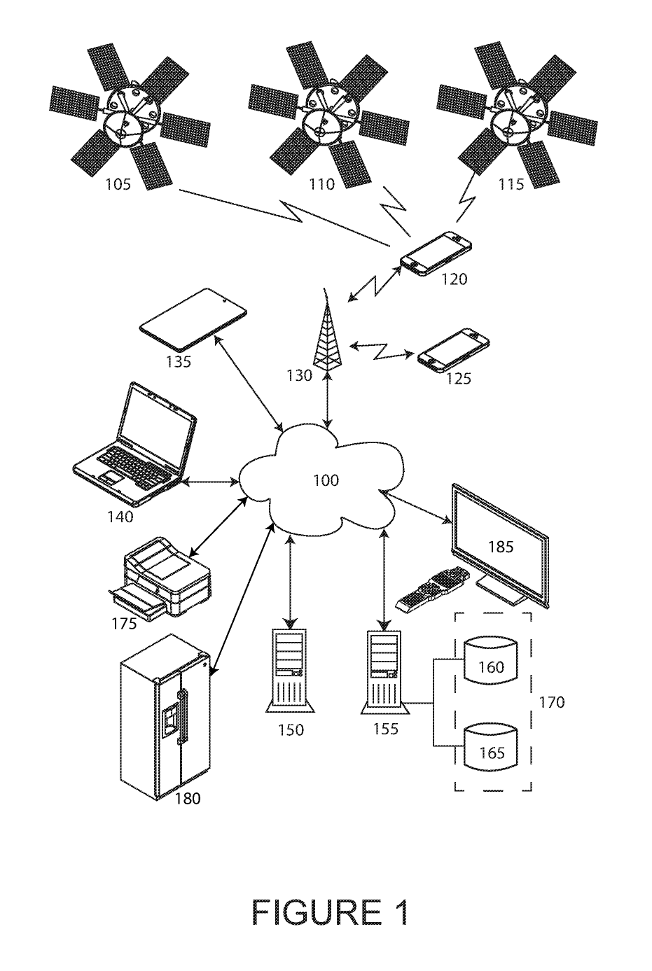

Referring now to FIG. 1, a high level block diagram of hardware components of a system according to one embodiment of the present invention is conceptually illustrated. Consistent with the present invention, users of the system use computing devices, such as a cellular phone 120, 125, a tablet 135, a laptop computer 140 and/or a desktop computer 150, communicating in a wireless or wired mode, with and through one or more web servers 155, via the Internet 100. The computing devices (i.e., clients or client devices) can be equipped with software for inputting and displaying information. Such software may comprise a web browser and/or a mobile device app. Some computing devices 120, 125 may be equipped with cellular wireless communication modules providing Internet access via wireless cellular communication infrastructure 130.

In certain embodiments of a system and methodology according to the principles of the invention, a user's location may be specified. Location may be user input or automatically determined using GPS data, IP trace, or triangulation information. Some computing devices may be equipped with Global Positioning System (“GPS”) receivers for receiving signals from GPS satellites 105-115 to determine a location of the device. Location information may be used for determining location for location-dependent services. Non-limiting examples of such services include, but are not limited to, restaurant, hotel, transportation, and live entertainment.

Certain client devices 120, 125, 135-150 may not have access to a GPS service. For instance, the client device may lack hardware necessary to support such a service. Consequently, such GPS information may not be available for all clients 120, 125, 135-150. Also, it is observed that certain GPS services do not operate or do not operate well in certain locations, such as indoors. Thus, even if a client device 120, 125, 135-150 does have the necessary hardware and software to support a GPS service, occasionally, GPS information from the GPS service may not be available to a particular client device 120, 125, 135-150.

IP trace information may include the public IP address of the client device 120, 125, 135-150 and the set of IP addresses that data packets sent from the client device 120, 125, 135-150 pass through to reach the server 155. The public IP address of the client device 120, 125, 135-150 may be determined by gathering the source IP address from the server socket receiving the client device 120, 125, 135-150 connection. The list of hops through which the data packets sent from the client device 120, 125, 135-150 go through may be determined by sending adaptive TTL (time to live) UDP packets to the server 155 from the client device 120, 125, 135-150. In order to determine if the client device 120, 125, 135-150 is being an IP proxy, the server 155 may correlate the list of hops with the public IP address of the client device 120, 125, 135-150. In this way, the server 155 may effectively discover the real public IP address of the client device 120, 125, 135-150. The real public IP address of the client device 120, 125, 135-150 may then be matched against a database of Internet Service Providers (ISPs) which returns the probable address of the originating client device 120, 125, 135-150 message. This probable address of the originating client device 120, 125, 135-150 message may then be translated to a set of longitude and latitude coordinates.

Triangulation information for a client device 120, 125, 135-150 may include a list of public Wi-Fi access points surrounding the client device 120, 125, 135-150 as well as the signal strength of each Wi-Fi access point accessible by the client device 120, 125, 135-150. The list of surrounding Wi-Fi access points, and their signal strength, may be formatted and correlated with a database of public Wi-Fi access points by the server 155 to determine a probable set of longitude and latitude coordinates for the client device 120, 125, 135-150. The database of public Wi-Fi access points employed by the server 155 may be updated over time to reflect new information about available Wi-Fi access points.

As can be appreciated, embodiments of the present invention are not dependent upon location information. Certain implementations of the invention may not take location into consideration. In implementations that take location into consideration, certain types of location data may be more accurate or reliable than others. GPS information is more accurate and indicative of the correct physical location of a client device 120, 125, 135-150; however, as explained above, GPS information for a particular client device 120, 125, 135-150 may not always be available. Triangulation information, while not as accurate and reliable in identifying the correct physical location of a client device 120, 125, 135-150 as GPS information, is more accurate and reliable than IP trace information. However, triangulation information also may not always be available. For instance, the client device 120, 125, 135-150 may not be able to detect any nearby recognizable Wi-Fi access points. Additionally, while IP trace information is less accurate than either GPS information or triangulation information in determining the correct location of a client device 120, 125, 135-150, it is always obtainable if the client device 120, 125, 135-150 can communicate to the server 155 over the Internet.

Additionally, a consumer may input location (e.g., an address) for a device, such as a laptop 140, desktop computer 150, or tablet 135, that may not be equipped with a GPS receiver. For a device, such as a desktop computer, at a fixed location, the location of the device may be known and associated with a unique identifier (e.g., MAC address) for the device.

The term “service provider” is used herein to mean any entity that provides a service using a system or methodology according to principles of the invention. The service provider may be, for example, an online service provider with a web-accessible system that receives and processes directives and marketing objects according to principles of the invention. The term “consumer” or “customer” is used herein to mean any individual or entity that requests or seeks marketing objects or goods or services of a business, whether for free or in exchange for compensation. The term “user” or “end user” is used herein to mean any individual or entity that uses the system, whether as a business promoting goods or services or as a consumer interested in procuring goods or services.

Using the computing device 120, 125, 135-150 and client software (“client”), such as a browser or app, a user may create a directive. A directive can comprise an authoritative instruction requesting or initiating an electronically deliverable service or information (e.g., a marketing object). A directive may be a consumer directive or a marketing directive. A consumer directive may be one of many different types including, but not limited to, a location directive, a personal information directive, a general directive, a specific directive, an aggregate directive, and/or a future directive.

The system can store data for each directive as one or more records in a database 170. A user may access, change, and delete directives using the system. The database 170 may be stored on one or more storage devices 160, 165, collectively the data storage 170. The database may be queried using various database access means such as SQL (Structured Query Language), a standard language for interacting with a database; Open Database Connectivity (ODBC), an open standard API for accessing a database; DCOM (Distributed Component Object Model), a set of Microsoft tools and program interfaces for enabling client program objects to request services from server program objects on another networked computer; Common Object Request Broker Architecture (CORBA), an architecture and specification which allows programs at different locations and developed by different vendors to interact in a network through an interface broker. Illustratively, the client devices 120, 125, 135-150 may execute one or more processes that interact with the server 155 to access data, such as product data, stored on the data storage 170. Each request received by the server 155 may be submitted as a TCP/IP communication packet including an IP address and socket number. In response to valid requests, the server 155 may provide data from the data storage 170, without compromising the integrity of the database.

The service provider's computing device 155 includes a server (e.g., web server) accessible via a network such as the Internet 100. The server 155 can be communicatively coupled to one or more databases 160, 165 and operates a database management system (DBMS) that stores, updates, sorts, queries and analyzes structured data in one or more databases 160, 165, and produces reports and output based on the data. The databases 160, 165 may reside on or local to the server 155, or remote from the server, hosted by a third party and accessible via a network such as the Internet 100. Collectively, the databases are referred to as a database 170.

Referring still to FIG. 1, one or more computers such as the server 155 can include, or have access to, a database management system for managing product data. One or more databases may contain aggregations of data records or files, pertaining to products, users, and directives. A communications network can interconnect the server 155, directly or indirectly through one or more additional computers, with the internet 100. Interconnected computers communicate with each other through mechanisms such as interprocess communication, remote procedure call, distributed object interfaces, and various other program interfaces.

The equipment 175, 180 can be registered for use with the system. An original message or a copy of each message from the registered equipment may be routed to the server 155, which, upon receiving the message, decodes it and determines the user, equipment and message content. If the message indicates a need for goods or services (e.g., toner or ink cartridges required for a printer, a water filtration element required for a refrigerator, an oil filter and oil required for an automobile) a corresponding aggregation directive may be generated. If the original message, rather than a copy is received by the server 155, the server 155 may send a copy of the original message to another destination (e.g., a service provider or manufacturer).

IoT equipment, such as printers 175 and appliances 180 (e.g., televisions, refrigerators), and vehicles that are communicatively coupled to the Internet 100 may also communicate with the one or more web servers 155. A game console coupled to a television, recording/reproducing (DVR) device coupled to a television and a SmartTV 185, are additional non-limiting examples of computing devices (i.e., computers) that users may use to interact with a system according to principles of the invention and enable performance of methods in accordance with principles of the invention, including receiving and displaying information and sending information. Any device that may process and send data to and receive data from the server 155 via the internet 100 and display textual and graphical information on a monitor constitutes a computer for purposes of the invention.

A location directive can identify a user and can provide location information for the user. The location information may comprise an address such as a home, business, temporary address, or another location. In some instances, a location directive may be time bound. For example, the location directive may be effective for a user-specified period of time.

A personal information directive may provide information related to the user. For instance, the personal directive may include, but is not limited to, gender, race, age, religion, marital status, income level, education level, profession, and personal interests. The personal information directive may be implemented to facilitate delivery of marketing objects pertaining thereto. Items of data may be optional, to accommodate users with heightened sensitivity to privacy and/or anonymity.

Typically, a general directive can remain active until canceled. The general directive can identify goods, services, categories of goods and services, brands, or other identifiable classificatory division of subject matter that may be of interest or desired by a user. The general directive can identify the user and the subject matter of interest. A graphical user interface may present a user with a form that allows a user to identify a multitude of subject matters of interest. From the form, a general directive may be produced for each subject matter. By way of example and not limitation, one category may be pickup trucks and another category may be Ford F150 ® pickup trucks.

A specific directive can be a specific request. The specific directive can identify goods, services, categories of goods and services, brands, or other identifiable classificatory division of subject matter that may be required or desired by a user. The specific directive identifies the user and the subject matter required. A graphical user interface may present a user with a form that allows a user to identify each subject matter required. From the form, a specific directive is produced for each subject matter. Specific directives may be processed immediately or as soon as practicable. In some instance, the specific directive may be time bound. For instance, the specific directive may be limited in duration. For example, limited to a day, a week, a month, until an end date, etc. By way of example and not limitation, a specific directive may request coupons for a particular business. The specific directive may be limited to a particular day when the coupons are needed. After that day, the coupons will not be provided unless requested again.

A future directive can be similar to a specific directive, but the future directive can identify goods, services, categories of goods and services, brands, or other identifiable classificatory division of subject matter that a user wishes to know about when said information is available. For instance, a user may create a future directive to be informed when a certain product is available. For example, a user may create a future directive to be notified when a particular color of a pair of Air Jordans is released.

A marketing directive can instruct the system to which users the system should send a corresponding marketing object. A marketing directive may specify users by subject matter of interest or by personal attribute or by location, as set forth in consumer directives (e.g., location, personal, specific or general directives). A marketing directive can be associated with a marketing object. The marketing object can be an image, file, stream, or data that will be forwarded to each user with a consumer directive that matches a marketing directive. The marketing object may be stored in the database 170.

Time bound provisioning is available. All directives may be time bound. In other words, a directive may be active for a limited period of time, defined in hours, days, weeks, months or years. For example, a general directive may be time bound for a year. The user associated with the general directive may receive a reminder of the time limit prior to the expiration, giving the user a chance to re-provision or remove the time limit. As another example, a merchant user may impose a time limit on a marketing directive for a coupon. The marketing directive may expire on a determined date. Time provisioning, the user can make a purchase once the marketing object of information is calendared or scheduled for notification.

A database management system executable via the server 155 can save each received directive as a record in a database referred to as a directive repository 160, 165. Directives and marketing objects may be stored in the same or separate databases. Consumer directives and marketing directives may be stored in the same or separate databases. Other data, including user account data and online shopping data may also be stored in repositories 160, 165 or one or more other databases.

The database management system, also referred to as an engine, provides processing, including querying and distribution. Querying can entail searching for, and retrieving, information from the database 170. By way of example, a query may be run for each marketing directive to identify matching consumer directives. Then, each marketing object associated with the marketing directive may be provided to or made accessible to the user associated with each matching consumer directive. If a user has several consumer directives that match a marketing directive, only one copy of the marketing object should be sent or made available. In one instance, one or more copies of the marketing object may be sent or made available to the consumer. A consumer directive matches a marketing directive when the consumer directive identifies the subject matter of the marketing directive. Marketing objects may be provided to users by sending copies, such as by email or SMS messaging, or by providing a link or other form of notification for the user to access or download the marketing object. In this manner, businesses may push advertisements, information, and coupons to consumers.

A marketing object may be provided by a consumer or a business. A marketing object may comprise any of a wide variety of marketing items including, but not limited to, coupons, announcements, advertisements, promotional codes, job postings, resumes, personal profiles, etc. Thus, as one non-limiting example, a marketing object may comprise a coupon (as broadly defined above) for a restaurant to be sent to all users in a certain location (e.g., northeast Florida) who have entered a directive for restaurants, or restaurants of the particular type, or that particular brand of restaurant. As another non-limiting example, a marketing object may comprise an individual's resume, to be made available to all business users in a certain location (e.g., southern California) who have posted a consumer directive seeking employees in the field of endeavor specified in the marketing directive associated with the resume. As yet another example, a marketing object may comprise information about a new product or event to be sent to all users who have expressed interest in the product or event, or in products or events of the kind.

The system can include a portal for registered users to access features of the system. The portal may be accessed via a web page and/or an app (e.g., an application executable on a computing device). Through the portal, a user may create a directive and/or provide a marketing object. The portal may provide user-navigable forms to facilitate directive creation and marketing object submission.

Illustratively, a form may include form controls and fields to be manipulated and completed by a user. The controls and fields may include, but are not limited to, check buttons, radio buttons, sliders, flip flopping windows, list boxes, drop-down lists, spinners, combo boxes, text boxes and upload buttons. The form data can be associated with the user account. The form data can specify the subject matter of the directive. The form data for a user can be stored in one or more databases 160, 165 of the system. The user may retrieve, edit, deactivate, and otherwise modify the user's form data using the portal.

The system may receive location information from users in the form of a location directive. Location information may comprise a home address, a business address, one or more other addresses, or a current location of the user as determined from location data such as GPS data from a user's smart-phone or other electronic device. The system may utilize a location directive to provide, to a consumer-user, local marketing objects responsive to a directive.

Businesses may create, modify, activate, and deactivate advertisements and coupons using the portal. The portal can allow businesses to manage marketing directives. Business users may track all of their marketing directives and associated advertisements, coupons and other marketing objects using the portal. An existing marketing directive may be modified, activated, deactivated, renewed, and reactivated. New marketing directives may be created. The value of a coupon may be changed by a business. A business may temporarily limit a coupon to a day, days, weeks, months or any combination of dates. Usage data for a marketing directive may be monitored. Reports may be produced to summarize marketing directives and associated data. Additionally, using the portal, a business may create a web page, which may include a description of the business, its products, key personnel and contact information.

A specific directive may include current location information for a user. Thus a user may request a location-specific marketing object. Location information may be specified by a user in a directive (e.g., via entering an address, zip code, city or some other geographical identifier), or by selecting a capture location button, or automatically using a GPS receiver (or other means) of the computing device. In the latter case, upon installation of an app or upon first use, a user may authorize automatic location determination from a device's available GPS receiver or by other means (as discussed above).

Where location specific directives are processed, the service provider system 155 may respond with marketing objects for the particular location or in the vicinity. The vicinity may be defined by one or more zip codes, a geographical area defined by a radius, or some other means for determining nearby merchants. The vicinity may be limited by a mode of travel, as inputted by a consumer. By way of example, the vicinity, for walking, may comprise a more limited area than the vicinity for driving. In one preferred embodiment, the service provider system 155 responds with a number of marketing objects for the closest merchants of the type requested. For example, the service provider system 155 may respond with five, seven, ten, or some other number of coupons for the closest restaurants of the type requested in a consumer directive.

By setting a vicinity as described above, the distance a user may travel to take advantage of an offer may be set by the user, so that offers too far away will be filtered. Conversely, businesses may want to target local consumers, limiting their marketing directives to users within specified geographic areas. Again, this may be accomplished by setting a vicinity for a marketing directive.

The service provider system 155 archives directives, including the date and time of the directive, a geographic identifier (e.g., zip code) for the directive, and the subject matter requested. Each directive is associated with a user's account. The archived information may be useful. For instance, knowing how many requests for a particular type of merchant in a particular geographic area and on what days and at what times, is useful for determining whether and how a local merchant may benefit from participating in a system according to principles of the invention. Such information can also be useful to existing and prospective participating merchants and advertisers. Concomitantly, savings realized by consumer-users and other successes may be determined from the archived data.

Marketing objects provided with the system may include a unique code for each copy provided to each user. For example, the code may be a field (e.g., function) that is based upon the user's unique identification. In this manner, it may be possible to determine not only how many marketing objects (e.g., coupons) were distributed, but also, how many were actually used and by whom.

In one implementation, upon receiving data in response to a request for merchants of a particular type, the consumer's computing device 120, 125, 135-150 may receive from the server 155 and display data pertaining to merchants of the type requested in the vicinity of the consumer. Such data may include graphical, textual, audio, and/or video information, one or more of the foregoing, individually and in combinations. The data may include a merchant's name and address, contact information for the merchant, location information for the merchant, popularity as determined from cumulative total selections by consumers, consumer rating information such as a numerical rating or icon rating using notations such as a number of stars, spoons, chef's hats or the like, or some other indicator of a degree of consumer satisfaction. Thus, for example, a consumer computing device 120, 125, 135-150 may display a hyperlinked list of local merchants of the requested type in a particular order. The default order of display may be user selectable or fixed. The order of displayed local merchants may be sorted by proximity, consumer ratings, popularity, or some other distinguishing category.

Using one or more applications executed on the computing device 120, 125, 135-150, a consumer may navigate through the list, select a merchant to view additional information about the merchant, initiate an order process and input information and make selections to complete an order. Thus, for example, in the case of a list of local restaurants, a consumer may select a particular restaurant to view a menu for the restaurant. Additional information for a merchant may be provided from the service provider's system via the Internet 100 as a merchant is selected. Using the computing device 120, 125, 135-150, a consumer may navigate from the menu, back to the list, where the user can select another restaurant and continues reviewing menus. A menu may include product or service descriptions, product or service images, audio, video, pricing information, hyperlinked consumer reviews, and other information. Menu details may be displayed as selectable pictograms. Thus, menu items may be user selectable using the computing device 120, 125, 135-150 to add to a consumer's online shopping cart for the system. A user selectable button (e.g., user interface element that provides a user a way to trigger an event) for adding an item to a cart may be provided. When a menu item is selected or when a corresponding add to cart or purchase icon is selected, using the computing device 120, 125, 135-150, then the consumer is prompted to enter any necessary additional information, such as quantity or special requests (e.g., hold the pickles). An add-to-cart button may be associated with a quantity drop down list or combo box for specifying a quantity for an item added to a shopping cart. The menu item, quantity, and additional information may be stored in a shopping cart associated with a consumer's account. One example of such additional information, as indicated above, is special requests such as food preparation requests. Other types of special requests may include deferred delivery or recurrence. For example, a consumer may place an order for processing and pickup at a future date. As another example, a consumer may place a recurring order (e.g., a recurring weekday coffee order).

As another example, a subject matter of interest in a consumer directive may be a particular entertainer such as a specific musician, band or comedian. A marketing directive may identify as the subject matter of the marketing directive such entertainer in a particular location. The marketing object may comprise an announcement of a performance scheduled at that location and information pertaining to ticket sales. The system may send the marketing object to all users in the vicinity of the location who have identified the specific entertainer or genre of entertainment in a consumer directive. Thus, consumers may be notified of live performances, special appearance, book signings, talk show appearances by a particular celebrity, and the like.

As another example, which is a variation of the preceding example, subject matter of interest in a consumer directive may be a particular genre of live entertainment such as live rock, live country, stand-up comedy, a television show, an actor, a book, an author, an athlete, and a sporting event. A marketing directive may identify as the subject matter of the marketing directive a particular entertainer in a particular genre of entertainment performing live in a particular location. The marketing object may comprise an announcement of a performance scheduled at that location and information pertaining to ticket sales. The system may send the marketing object to all users in the vicinity of the location who have identified either the particular entertainer or genre in a consumer directive.

As another example, a consumer directive may identify a particular restaurant or a particular type of restaurant, or all restaurants. A marketing directive may be submitted for a restaurant in the vicinity of the consumer's then-current location, or in the vicinity of an address associated with the consumer. In each case, the marketing object associated with each such marketing directive will be made available to the consumer by the system.

As yet another example, a specific directive may seek all coupons for a particular retailer. Each active marketing directive from the retailer for a coupon may be retrieved in a query run in response to the specific directive. The associated coupons, as marketing objects, may then be made accessible to the consumer.

As still another example, a specific directive may seek all coupons for a particular manufacturer. Each active marketing directive from the manufacturer for a coupon may be retrieved in a query run in response to the specific directive. The associated coupons, as marketing objects, may then be made accessible to the consumer. Alternatively, a directive may seek marketing objects representing savings (e.g., coupons, sales or discounts) of a certain level for a particular product or range of products.

As another example, a specific directive may seek a coupon for a particular product. Each active marketing directive for a coupon for the product may be retrieved in a query run in response to the specific directive. The associated coupons, as marketing objects, may then be made accessible to the consumer. The product may be identified by a UPC code, brand and model, or by a barcode (e.g., a barcode imaged by a user using a mobile device).

A unique identifier can be associated with each user. The identifier may be assigned at the time the user registers. Similar to a consumer loyalty card account number, the identifier may be utilized at compatibly equipped points of sale, whether brick and mortar or online, to apply coupons. To be compatibly equipped, the point of sale must be configured to transmit data to and receive data from a system according to principles of the present invention. A user may be required to enter a PIN or password at checkout to authorize the transaction. The identifier may be stored on a magnetic stripe, as a scannable/readable barcode, electronically in a smart card, or on the display screen of a mobile computing device, or in a wirelessly communicated signal, or in a data packet communicated via network communication. The identifier not only identifies the user, but also identifies the system. Therefore, the point of sale system may poll the system of the invention for applicable coupons for the user.

In one embodiment, a Web crawler can systematically browse the World Wide Web for the purpose of populating the databases 160, 165 with system-generated marketing directives or marketing objects. Starting with a list of seed URLs, the Web crawler can visit the URLs, identify all the hyperlinks in the page and add them to the list of URLs to visit. Such URLs are recursively visited according to a set of policies. The Web crawler can copy and save website information as it goes. Copied information may include photos, product descriptions, pricing information, and URLs for each product on-sale on a website visited by the crawler. This information may be used to create a system-generated marketing directive and can be completely synchronized to match the consumer directives. (e.g., reduced pricing to specific marketing objects) The system may employ a metric of importance for prioritizing Web pages, by evaluating intrinsic quality and popularity in terms of links or visits. The importance of a page for the crawler can also be expressed as a function of the similarity of a page to a given query.

The system-generated marketing directive can be associated with a product description and a photo as a marketing object. The marketing object can be forwarded to each user with a consumer directive that matches a marketing directive. The marketing object may be stored in the database 170.

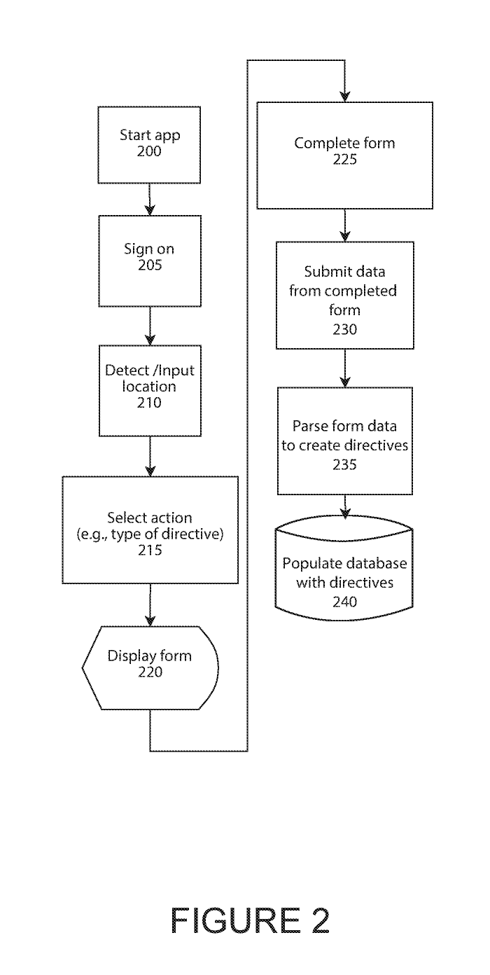

Referring now to FIG. 2, a high level flowchart conceptually illustrates steps of an exemplary directive methodology for an exemplary system according to principles of the invention. The methodology may be performed using an application, according to step 200. After signing in, as in step 205, the location of the user may be determined using any of the location determination techniques discussed above, as in step 210. The user then selects the action to be performed, from a plurality of available actions, as in step 215. Among the available actions is creating a new request. The action may be identified in lay terms as “Request Coupon” or “Request Marketing Info” or the like. Upon selecting the action the user is presented a form to complete, as in step 220. The form may include controls and fields to gather information for the directive. The directive is associated with the user's account and the time and date. After the user completes the form, as in step 225, it is submitted to the database management system 170, where it is stored as one or more records in a database 160, 165, as in step 230. The system parses the form data, as in step 235, to create records (e.g., directives) to populate the databases 160, 165, as in step 240.

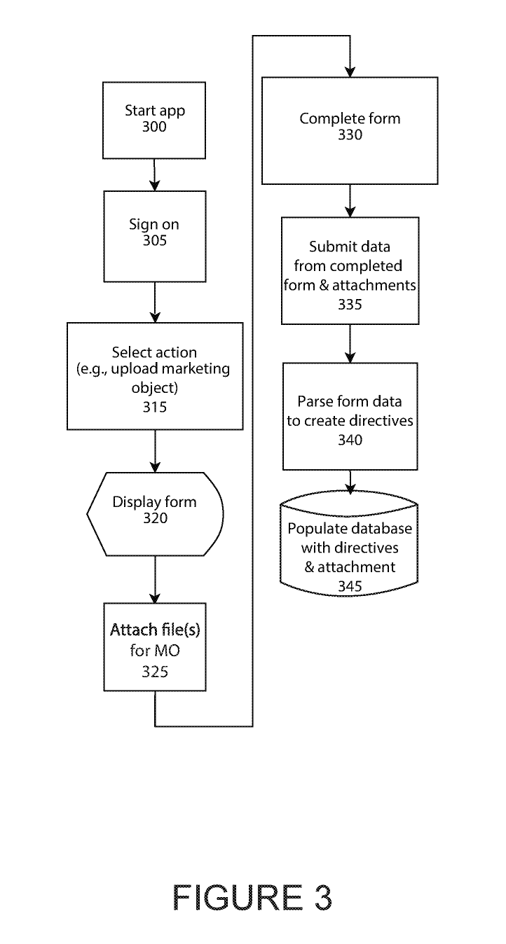

Referring now to FIG. 3, a high level flowchart illustrating steps of an exemplary marketing directive methodology for an exemplary system according to principles of the invention is shown. The methodology may be performed using an application, according to step 300. After signing in, as in step 305, a business-user selects the action to be performed, from a plurality of available actions, as in step 315. Among the available actions is creating a new marketing directive. Upon selecting the action the user is presented a form to complete, as in step 320. The form may include controls and fields to gather information for the directive. The directive is associated with the user's account and the time and date. One or more marketing objects, such as a coupon, is associated with the directive and uploaded, as in step 325. After the user completes the form as in step 330 and attaches the object as in step 325, the data and object are submitted to the database management system 170, as in steps 335. The system parses the form data, as in step 340, to create records (e.g., directives) to populate the databases 160, 165, as in step 345.

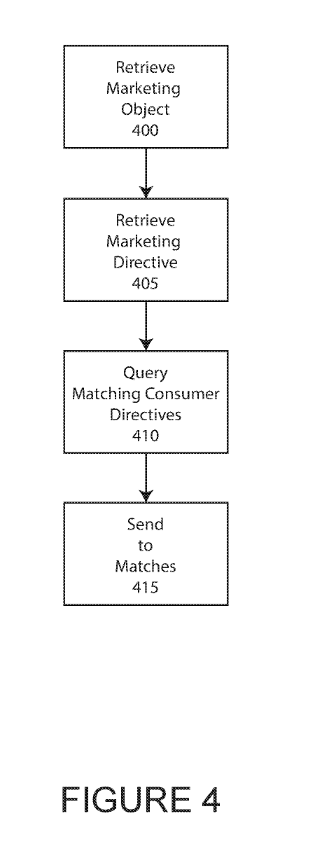

Referring to FIG. 4, a high level flowchart illustrating steps of an exemplary matching methodology for an exemplary system according to principles of the invention is shown. The system 155 retrieves a marketing object and marketing directive in steps 400 and 405. Then, in step 410, in accordance with the specifications of the marketing directive, the system queries the database(s) 160, 165 to determine which consumer directives match the marketing directive. The marketing object can be sent to users associated with matching consumer directives in step 415.

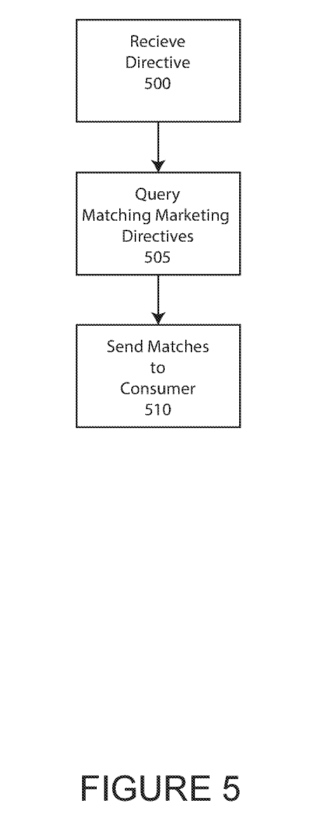

Referring now to FIG. 5, a high level flowchart illustrating steps of an exemplary specific directive processing methodology for an exemplary system according to principles of the invention is shown. Upon receiving a specific directive (e.g., a consumer-user's request for a coupon or some other marketing object), as in step 500, the system queries the database in accordance with the specific directive, searching for matching marketing directives and associated marketing objects in the database(s), as in step 505. Matching marketing objects are sent to the user, as in step 510. Thus, a user may submit a directive that requests a coupon for a particular product or service. In response, the system will locate marketing objects responsive to the submission.

In one embodiment, a system according to principles of the invention disseminates marketing objects of marketing directives that are responsive to consumer directives upon receipt of the marketing directive. The marketing directive may be input by a vendor or obtained by an automated process, such as web crawling. Upon receipt of a marketing directive, the system determines the consumer directives, if any, to which it is responsive, and disseminates the marketing objects associated with the marketing directives in an appropriate manner, as soon as possible. In this manner, a consumer may receive timely notifications of time-sensitive sales, events, news and other matters.

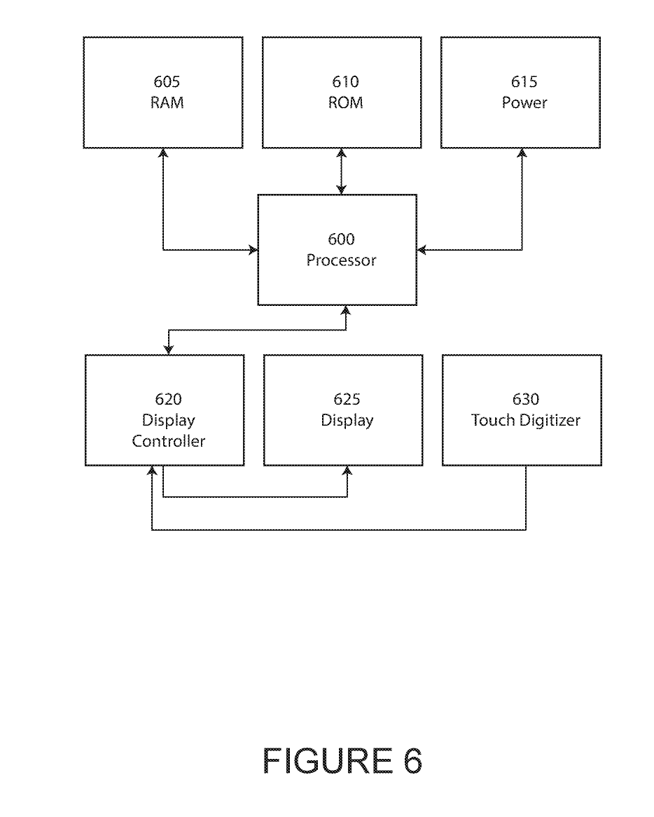

Mobile device 120, 125 is a computing device as described above in reference to FIG. 1. With reference to FIG. 6, the device 120 may include one or more processing units (CPU's) 600, memory such as RAM 605 and ROM 610, and a power supply 615. Additionally, the device 620 may include a display controller 620, a display 625 and a touch digitizer 630. These may comprise merely a few of the components of the mobile device 120. Various components may be implemented in hardware, software, or a combination of both hardware and software, including one or more signal processing and/or application specific integrated circuits.

The touch digitizer 630 may comprise a touchscreen, an electronic visual display that the user can control through simple or multi-touch gestures by touching the screen with a special stylus/pen and-or one or more fingers. The touchscreen enables the user to interact directly with what is displayed, rather than using a mouse, touchpad, or any other intermediate device (other than a stylus, which is optional for most modern touchscreens). The touch digitizer 630 further comprises a transparent overlay covering the visual display. The overlay senses the touch of one or more fingers or a stylus. In response to a touch, the overlay produces a change in electrical properties (e.g., a change in current, voltage, capacitance or resistance). The touch digitizer interprets the commands that the changed electrical properties represent and communicates the commands to the appropriate applications. The touch digitizer 630 further comprises a display controller that receives and/or sends electrical signals from and to the visual display and overlay. Visual output may include graphics, text, icons, video, and any combination thereof (collectively termed “graphics”). In some embodiments, some or all of the visual output may correspond to user-interface objects. The display controller (along with any associated modules and/or sets of instructions in memory) detect contact (and any movement or breaking of the contact) on the overlay and converts the detected contact into interaction with user-interface objects (e.g., one or more soft keys, icons, web pages or images) that are displayed on touch-sensitive display. In an exemplary embodiment, a point of contact between touch digitizer 630 and the user corresponds to a finger of the user. The visual display may comprise LCD (liquid crystal display) technology, LPD (light emitting polymer display) technology, or LED (light emitting diode) technology, although other display technologies may be used in other embodiments. The overlay and display controller of the touch digitizer 630 may detect contact and any movement or breaking thereof, including speed (magnitude), velocity (magnitude and direction), and/or an acceleration (a change in magnitude and/or direction) of the point of contact, using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display. These operations may be applied to single contacts (e.g., one finger contacts) or to multiple simultaneous contacts (e.g., “multitouch”/multiple finger contacts).

Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

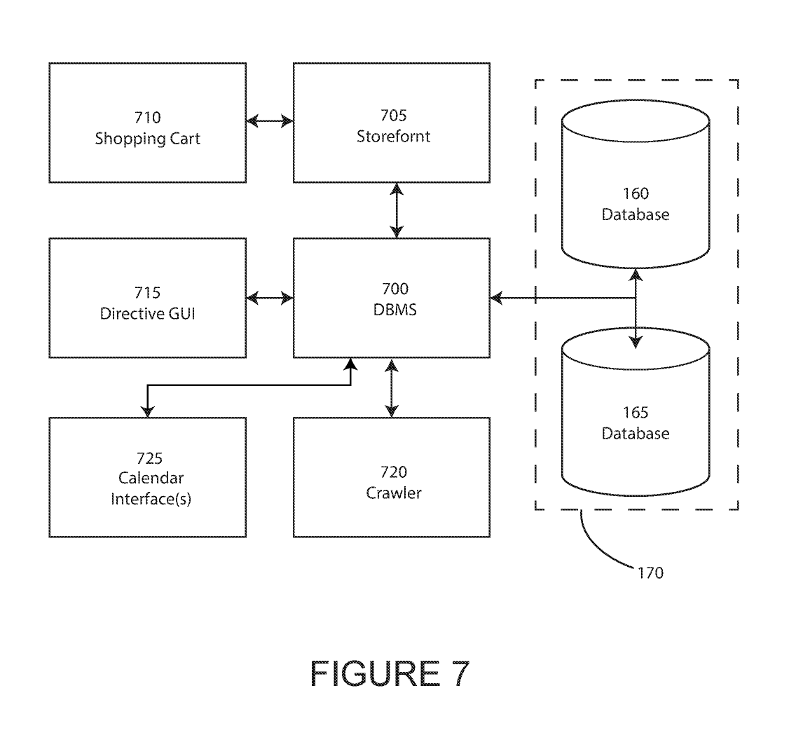

Referring now to FIG. 7, various modules of an exemplary system according to principles of the invention are conceptually illustrated. Modules may be implemented in hardware and/or in software (including firmware, resident software, micro-code, etc.). The database management system 700 (DBMS) can store, update, sort, query and analyze structured data in one or more databases 160, 165, and produce reports and output based on the data. Collectively, the databases are referred to as a database 170 or a repository or the like.

As repositories for product information, the database 170 may supply data to one or more online storefronts. The system may provide one or more storefronts 705 for online shopping. The storefront 705 is a Web store that is accessed by users to shop. Products offered for sale may be presented from the database 170. Users may shop for goods and services via the storefront 705. Merchants may include their products in the store using a storefront administration system or by listing the products through marketing directives. A purchase icon may be displayed with items identified in marketing directives and on product pages of the storefront. Category, product, and other pages (e.g., search, bestsellers, etc.) may be dynamically generated by the storefront based on the information saved in the database 170. By selecting a purchase icon, a shopping cart system 710 is triggered. The shopping cart system 710 is e-commerce software on a web server that allows users to select and accumulate a list of items for purchase. Upon checkout, the system 710 calculates a total for the order, including shipping and handling (i.e., postage and packing) charges and taxes, as applicable. The shopping cart system 710 provides a means of capturing a client's payment information. In the case of payment by credit card, the system 710 relies on a secure gateway provider, in conjunction with the secure payment gateway, in order to conduct secure credit card transactions online. A store administration system may be accessed by the merchant to manage the online shop. Using the administration system, a store manager may add and edit products, categories, discounts, shipping and payment settings, etc.

Using the computing device 120, 125, 135-150 and client software such as a browser or app, a user may create a directive. A Directive GUI 715 is the user interface for users to create and manage directives and implement slide-by displays. The interface includes controls and fields for directive creation and management and display of results. Management may entail activating, deactivating, reactivating, modifying and canceling a directive. As discussed above, each directive comprises an authoritative instruction pertaining to delivery of an electronically deliverable marketing object. The directive may be a consumer directive or a marketing directive. A consumer directive may be one of many different types, including, but not limited to, a location directive, a personal information directive, a general directive and a specific directive. The system stores data for each directive as one or more records in the database 170. Using the Directive GUI, a user may access, change and delete directives using the system. The GUI 715 allows a user to identify and select existing directives of that user and create new directives. A selected existing directive may be managed using the GUI 715. All existing directives may be displayed in a table, showing their title, creation date, effective dates, and other information related to the directives, to facilitate tracking and management.

One or more interfaces 725 allow communication of event data according to the API for each user's web calendar. The computer system adds events to calendar data for calendar's associated with the users. The event identifies the subject matter and includes a time. The addition is accomplished by sending the data for the event to the address for the calendar application in accordance with an API for the calendar application. Thus, for example, a user's calendar data is updated with a new event for a directive.

A web crawler 720 systematically browses the World Wide Web for the purpose of populating the database 170 with system-generated marketing directives and/or marketing objects. Starting with a list of seed URLs, the Web crawler visits the URLs, identifies all the hyperlinks in the page and adds them to the list of URLs to visit. Such URLs are recursively visited according to a set of policies. The crawler copies and saves website information as it goes. Copied information may include photos, product descriptions, pricing information, and URLs for each product on-sale on a website visited by the crawler. This information may be used to create a system-generated marketing directive. The system may employ a metric of importance for prioritizing Web pages, by evaluating intrinsic quality and popularity in terms of links or visits. The importance of a page for the crawler can also be expressed as a function of the similarity of a page to a given query. Crawler process may also be created from semantic intelligence which translates and coverts human language to machine language.

Data may be supplied to the database 170 through other sources. As an example, a data feed may be provided for the database 170 to receive updated data from supplier (e.g., vendor and/or designer) data sources (e.g., databases). By way of example and not limitation, a CSV data feed may be used to load a CSV file to load product information from a supplier's database. The file may contain all data for all products from the supplier's database. Alternatively, the file may contain data for products that have changed since the last CSV file provided.

Data may also be supplied to the database 170 through synchronization. One-way file synchronization, i.e., mirroring, may also be employed to update data copied into the database 170 from a supplier's data sources. Consistency among data from a supplier's source to the target data storage 170 may be established by timestamp synchronization. In this implementation, all changes to the source data are marked with timestamps. The time of all synchronizations are stored, at the source, at the target or at both locations. Synchronization proceeds by transferring all data with a timestamp later than the previous synchronization.

A supplier may also provide a portal (e.g., an enterprise information portal) (EIP), as a framework for making product information available. An administrator of a system according to principles of the invention may access the supplier's data through the supplier's EIP. Additionally, a system according to principles of the invention may automatically access the supplier's data through the supplier's EIP, such as by using a crawler to systematically browse the portal to update indexes and data in the database 170.

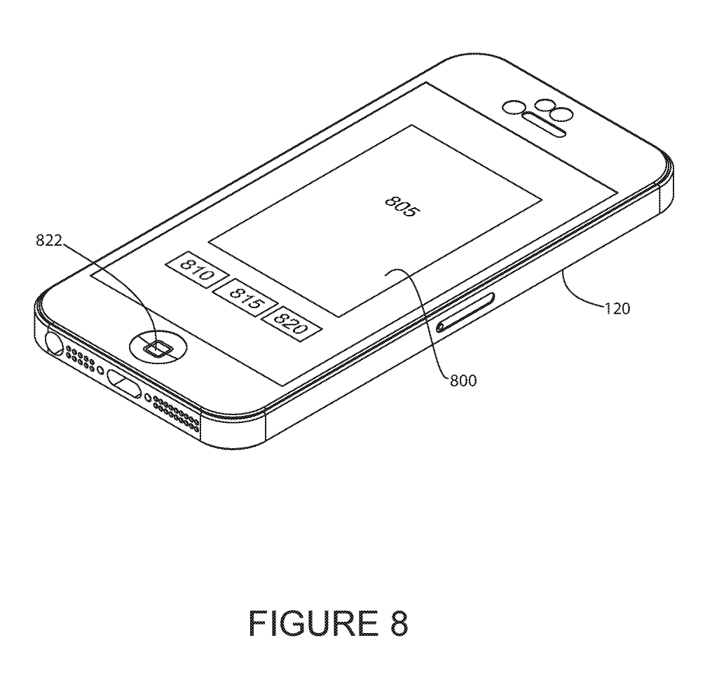

Referring now to FIG. 8, an exemplary mobile device 120 with a touch sensitive screen for use with an exemplary system according to principles of the invention is shown. The exemplary screen 800 displays a marketing object 805 and controls 810-820. The marketing object may be a coupon, discount code, product listing, product pictogram, or some other visual object. While three controls are shown, additional controls may be provided and located and arranged differently than as shown. The controls 810-820 trigger actions relative to the marketing directives and marketing object 805. The marketing object 805 may be removed from the screen 800 by swiping motion. In such case, the next or previous marketing object 805 in a series of marketing objects may be displayed on the screen 800. If there are no other marketing objects to display, a default display may be presented.

The displayed controls 810-820 may be dynamic, changing their content and functionality to work with the displayed marketing object 805. In one embodiment, the controls 810-820 may include a join button which allows a user to join an aggregate directive. Other possible controls 810-820 include a share button, allowing a user to send the marketing object or a link thereto to a friend; a block button, allowing a user to block such marketing object in the future; and a button to bring up more available actions. These non-limiting examples illustrate one example of a range of possible controls. Yet other possible controls 810-820 include actions related to a marketing object that may automatically create directives based on being selected, as will be discussed later on.

The app may be voice controlled. In one embodiment, control selections and other actions or directives may be performed using voice commands, using semantic intelligence which translates human language into machine language, using a microphone 822 and audio processing hardware and software of the mobile device 120.

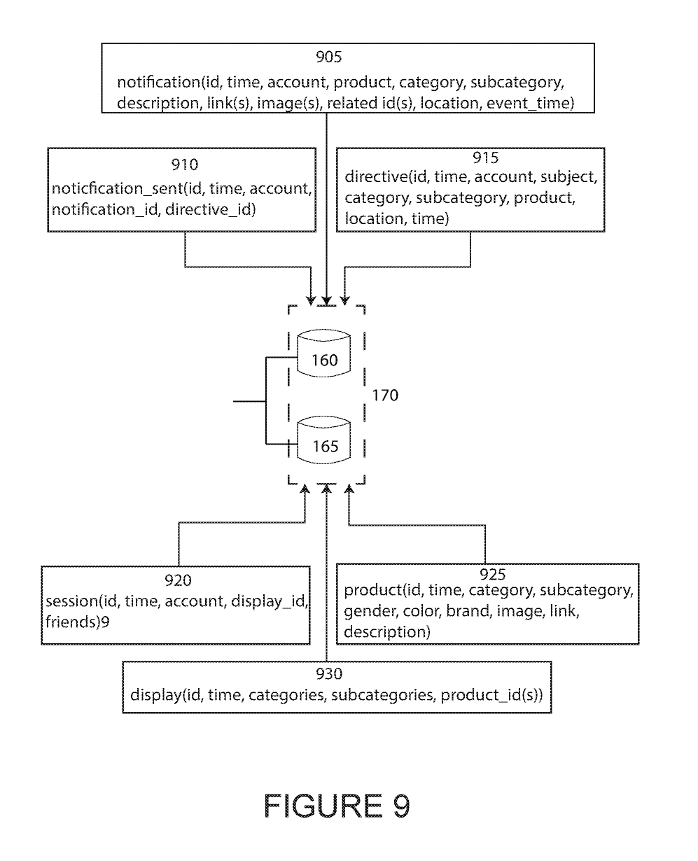

With reference to FIG. 9, an exemplary system according to principles of the invention stores and utilizes data pertaining to directives, notifications, user sessions, products and displays (e.g., slide-by-displays) on one or more data storage devices 160-170. Data storage may be transient or enduring. Stored data may include a notification 905. A notification 905 may be generated in response to a directive 915. Notifications may be pushed from a server 155 to a user (client) 120, 125, 135-150 based upon information preferences expressed in advance by the user. Various fields of data may be associated with each notification 905, including a unique identifier (id), a time of generation, an account (e.g., user account) associated with the notification, a product or service pertaining to the notification, categories and subcategories for the product or service, a description of the subject matter of the notification, links to relevant web pages, images or pictograms for the notification, identifications for other related products and services, location information, and event time for performances, broadcast, special events, appearances and the like. Notification sending data (notification sent) 910 may be stored to ensure delivery to all intended recipients and avoid duplicates. Various fields of data may be associated with each notification sent 910 record, including a unique identifier (id) for the record, a time of generation, an account (e.g., user account) associated with the notification, a notification identification, and a directive identification.

The notification is generated when a specified condition is satisfied. Conditions and notifications vary according to the subject matter. By way of example, a user may be notified when a product becomes available, is on sale (i.e., at a discount), or is offered by a vendor at or below a certain price, or is available as a refurbished or open-box item. A user may be notified when a vendor introduces a new product or a newer version or the next generation of a product. A user may be notified when tickets to an event are offered for sale. A user may be notified when a celebrity makes an appearance locally or on television, or is interviewed, or appears in a newly released movie, or makes a public announcement. A user may be notified of each show or movie at a particular venue. These are non-limiting examples of conditions and notifications.

A user may specify a condition for notification using a user interface with form fields. The fields vary according to the subject matter to which the notification pertains. In the case of a product, fields may include a selling price below which a user is willing to purchase the product, availability at a specified venue, coupons, public announcements, and other variables pertaining to the marketing and sale of a product. In the case of a celebrity, the conditions for which notifications may be provided may include television appearances, in-person appearances, shows, announcements and the like.

Various fields of data may be associated with each directive 915, including a unique identifier (id) for the record, a time of generation, an account (e.g., user account) associated with the directive, a subject for the directive, a category for the directive, each subcategory for the directive, a product or service identification for the directive, location information for the directive, and timing information for the directive. Data for each session 920 may include a session identification, time information such as a start and end time, an account (e.g., user account) associated with the session, an identification for the subject matter displayed, and information regarding friends that supplied or received data during the session. Session information 920 may be shared among friends to allow friends to view the same display. During a session, a user may view one or more products, such as goods, services or events. A product record 925 may include various fields of associated data, including a unique product identification, a time added to the database, a category and one or more descriptive subcategories, such as, for example, gender, color and brand information, an image or pictogram, a link (e.g., hyperlink), and a description. For each display, such as a slide-by display, a unique identifier, time information, categories and subcategories, and product identifications may be stored. Thus, information for a user to replicate a particular display is stored and made available for communication to third parties. The information includes information regarding the session, the products displayed and the categories and subcategories covered.

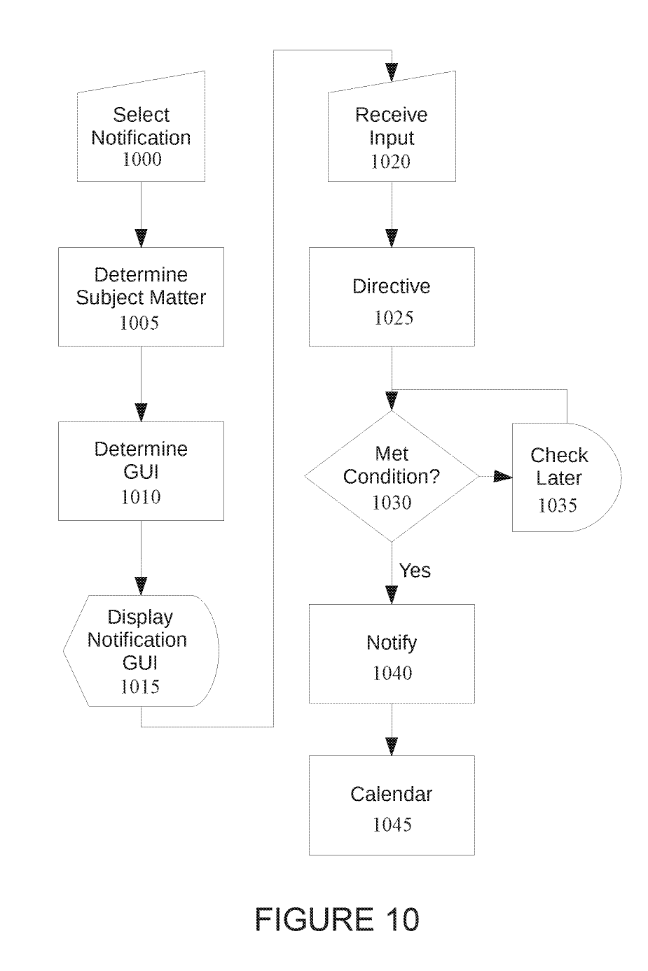

Referring to FIG. 10, a flowchart conceptually illustrating steps of a notification process is shown. A user may initiate a request for notification by selecting a notification icon, as in step 1000. The icon may be displayed adjacent to a display of the subject matter to which the notification pertains. Upon receiving a notification request, the system determines the type of subject matter to which the request pertains, as in step 1005. Upon determining the type of subject matter, the system determines the notification user interface to display for the determined subject matter, as in step 1010. The system correlates subject matter to available notification user interfaces. Each type of subject matter is associated with a notification user interface. The associations may be stored in tables or lists in the database 170. Upon determining the notification user interface to display, the system displays that user interface, as in step 1015. The user then supplies input through the user interface, as in step 1020. The user input specifies one or more conditions under which the user should be notified. The user may also specify one or more means for notification, such as a calendar posting, SMS, email, pop-up, or all or the foregoing then displays the determined user pertaining to subject matter displayed. A directive is generated using the user input and the subject matter, as in step 1025. Then, the system periodically repeatedly checks whether the condition(s) is(are) satisfied, as in steps 1030, 1035. When the condition(s) is(are) satisfied, a notification is sent, as in step 1040. The notification alerts the user of each condition that has been satisfied for the subject matter. The system may also push a notification to a user's calendar, associated with a user's account, as in step 1045. The calendar may be configured to provide alerts to a user, via email, pop-up or alarm, for time-sensitive notifications (e.g., an event commencing on a certain date at a certain time).

Actions can also be selected to interact with television to receive information from a particular product or service to buy from a phone instantly. Celebrities, promoters, designers, television networks, television shows (e.g., QVC) radio networks may use such functionality to promote their shows and the products featured in their shows. A user may be notified of the date and time that a televised or radio broadcasted event, performance or appearance is occurring, or a product is being displayed on TV or discussed on radio. The notification may include a calendar entry. Concomitantly, the system may include a list, for each show or program, of products that appear in the show or program by time and date. The list may be linked to the notification and calendar entry provided to the user. A television show's calendar may synchronize with the user's calendar on their phone in real-time. When an action is selected the product shown in real-time will have a control for the user to select in real-time on their phone displaying the product on one or more strips in order to make a purchase.

Various fields of data may be associated with each directive 915, including a unique identifier (id) for the record, a time of generation, an account (e.g., user account) associated with the notification, a subject for the directive, a category for the directive, each subcategory for the directive, a product or service identification for the directive, location information for the directive, and timing information for the directive. Data for each session 920 may include a session identification, time information such as a start and end time, an account (e.g., user account) associated with the session, an identification for the subject matter displayed, and information regarding friends that supplied or received data during the session. Session information 920 may be shared among friends to allow friends to view the same display. During a session, a user may view one or more products, such as goods, services or events. A product record 925 may include various fields of associated data, including a unique product identification, a time added to the database, a category and one or more descriptive subcategories, such as, for example, gender, color and brand information, an image or pictogram, a link (e.g., hyperlink), and a description. For each display, such as a slide-by display, a unique identifier, time information, categories and subcategories, and product identifications may be stored. Thus, information for a user to replicate a particular display is stored and made available for communication to third parties. The information includes information regarding the session, the products displayed and the categories and subcategories covered.

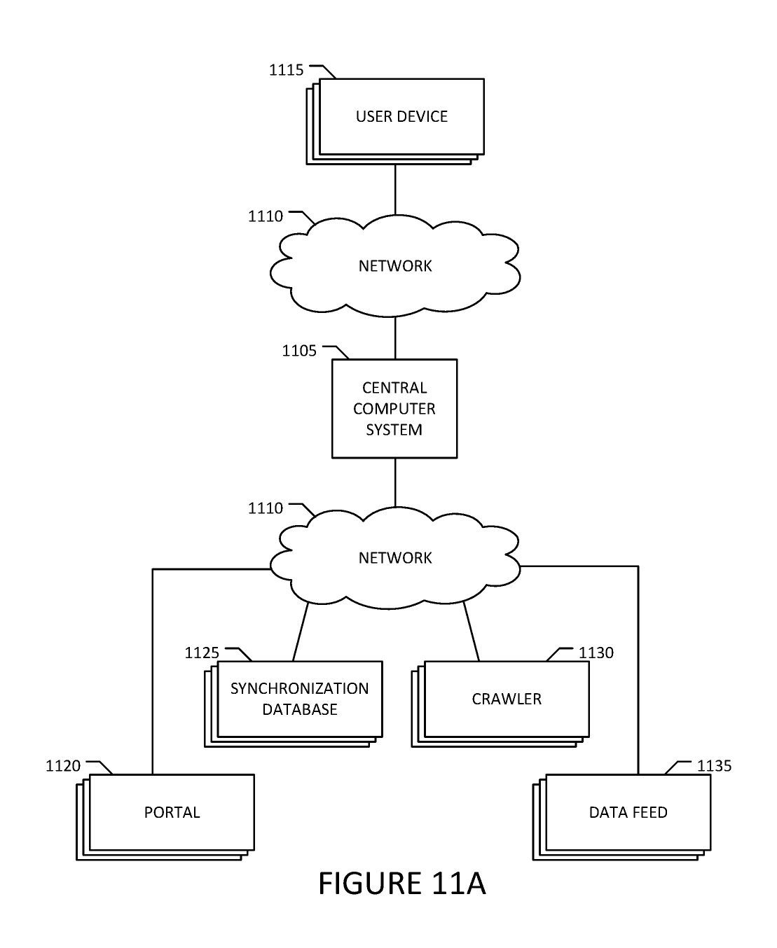

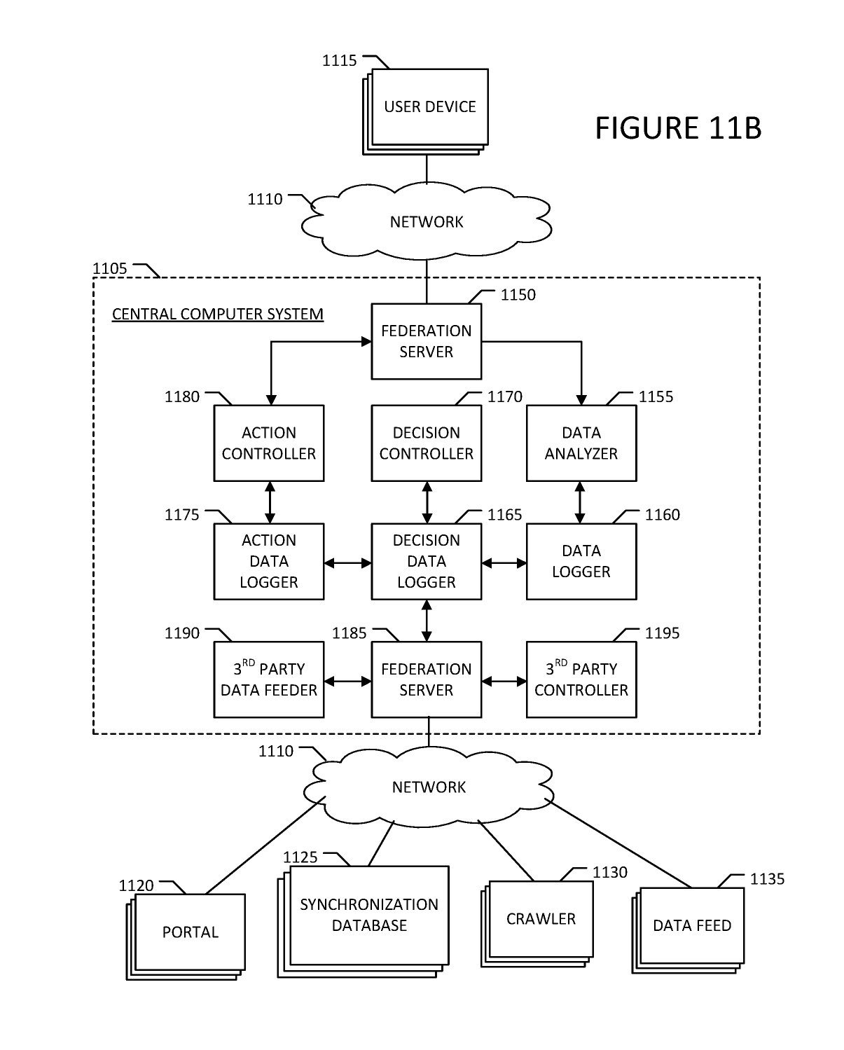

Referring to FIG. 11A, a block diagram of a system 1100 is illustrated. The system 1100 can be implemented to gather information from one or more sources to create, retrieve, find, and/or generate a marketing object to satisfy a directive created by a user.

As shown, the system 1100 can include, but is not limited to, a central computer system 1105, a network 1110, one or more user devices 1115, and a plurality of third party data sources 1120-1135. The third party data sources can include, but are not limited to, one or more portals 1120, one or more synchronization databases 1125, one or more crawlers 1130, and one or more data feeds 1135. As can be appreciated, the central computer system 1105 can include the previously discussed server 150 and the database 170. Of note, the one or more information sources 1120-1135 can populate the database 170 with data, marketing objects, and/or marketing directives.

In a typical implementation, a user can create a directive via the user device 1115. As can be appreciated, a retailer or company may create a directive via a user device 1115. Once the directive has been created, the directive can be sent to the central computer system 1105. Once the directive is received by the central computer system 1105, the central computer system 1105 can determine if information related to the directive is available to the central computer system 1105. For instance, the central computer system 1105 can implement a program or application to search for information related to a subject matter included with the directive. In one example, the application can search the database 170 to determine if there is a marketing object or marketing directive that includes a subject matter similar to the subject matter of the user directive. If the application determines that a marketing object is available in the database 170, the application can send the matching marketing directive to the user device.

If the application determines that the database 170 does not include information related to the subject matter of the user directive, the application can begin checking each of the sources 1120-1135 for data including information related to the subject matter of the user directive. In one example, the application can first check the one or more data feeds for data related to the user subject matter. Second, the application can check data accessible via the one or more portals for data related to the user subject matter. Third, the application can check data from the synchronized database for data related to the user subject matter. Fourth, the application can check data recently retrieved by the crawler that has not yet been indexed or stored in the database 170 for data related to the user subject matter. As can be appreciated, the application can stop checking from source to source after the application has found information related to the user subject matter. Further, the application can check the sources in a variety of different orders and the mentioned order is not meant to be limiting.

Once the application has found data related to the user subject matter, the application can retrieve, create, or generate the marketing object having data related to the user subject matter. The application may then send the marketing object to a device of the user.

In another implementation, if the application determines that the database 170 does include, or does not include information, the application can continuously check for information related to the user directive until the application receives an instruction to stop checking. In one embodiment, the application (or the central computer system 1105) can implement command memorization. Command memorization can include, but is not limited to, the application storing a user directive, and any associated actions, commands, and/or conditions, until the command has been satisfied. For instance, the application can memorize (or store) the user directive and continuously check for data related to the subject matter of the user directive. In one example, the application can continuously check and provide data until the user directs the application to stop. In another example, the application can stop checking once a condition of the user directive has been satisfied. The application can continuously send information to the user related to the subject matter of the user directive until the application is told to stop or put on hold. For instance, a user may generate a new directive via the user device 1115 to tell the application to stop checking for information related to the user directive and search for information related to a second subject matter of a second user directive. In another instance, the user directive may include a condition upon which when the condition is met, the application can stop searching for information related to subject matter of the user directive.

In one embodiment, each of the marketing objects can include a plurality of actions associated with a subject matter of the marketing object. Typically, each marketing object can be associated with a generic main category that includes a plurality of actions based on the generic category. Main categories may include, but are not limited to, sports, news, arts, fashion, entertainment, food, etc. Each of the main categories can include a plurality of actions that are designed for said main category. For example, fashion may include actions for following a designer, locating retail locations having a particular brand, requesting coupons for retailers, etc.

Typically, after a user has created and sent the user directive to the central computer system 1105, the application can search for a generic marketing object related to the subject matter of the user directive. For instance, the application may start by finding all information related to the subject matter of the user directive and search the database 170 for a generic marketing object that relates to the subject matter. Usually, the central computer system 1105 can determine a generic category for the subject matter of the user directive, and then find a particular marketing object from the generic category that includes information related to the subject matter. For example, a user may initiate a directive to receive information related to an actor. The central computer system 1105 may then find a marketing object from the generic category of entertainment that includes the actor. The computer system 1105 may then send the marketing object to the user device 1115 to display the information along with the plurality of actions included with the marketing object.

In some embodiments, the user directive may include an authoritative instruction to collect information related to the first subject matter including receiving marketing objects and/or event information from one or more subcategories or a second subject matter related to the first subject matter. The second subject matter and/or the subcategories may come with an authoritative instruction to be executed once selected by a user. For instance, the second subject matter and/or the subcategories may be one of the actions selectable included with the marketing object. In one instance, a selection of one or more subcategories can initiate command memorization until a condition is met or satisfied by a data source 1120-1135, or once the information has been made public knowledge.

In one example, a user may create a user directive having a subject matter related to Justin Bieber. The initial user directive may include a command to remind the user when Justin Bieber is on television. The central computer system 1105 can then search the database 170 for a generic marketing object related to Justin Bieber. When the central computer system 1105 finds the generic “Justin Bieber” marketing object, the central computer system 1105 can send the generic marketing object to the user device 1115. The user device 1115 can then be configured to display the marketing object including a plurality of actions selectable by the user. A first action may be “Remind me when Justin Bieber is one a big screen in the movie theater.” A second action may be “Remind me when Justin Bieber is in Concert in Denver, Colo.” A third action may be “Notify me when Justin Bieber is in magazines.” As can be appreciated, the first directive subject matter can represent Justin Bieber. A second directive may be automatically generated by the application when a user selects one of the actions presented with the generic marketing object. As can be appreciated, the second directive can be the selection, or one or more of the selected examples, to perform a duty and initiate command memorization to continue searching until a condition or command is met. A third user directive may tell the application to purchase Justin Bieber concert tickets automatically when Justin Bieber announces a show in Denver and send a receipt to a user email once the selected or chosen second directive conditions are met or satisfied from one or more of the sources 1120-1135. Of note, the third user directive may also be system generated. Each marketing object or event sent to the user may come with system generated directives for the user to choose from.

Referring back to FIG. 8 and as previously mentioned, the controls 810-820 may be actions presented with the marketing object 805. As can be appreciated, a user may select which of the actions 810-820 to interact with. By selecting one or more of the actions 810-820, the application can initiate, generate, or create one or more directives directed towards the selected action. For instance, an action may request the application to search and present information related to a sub-category of the marketing object. For example, the sub-category may include television shows the actor has appeared on and when those shows will be airing on television.

In some embodiments, the actions included with the marketing objects presented to a user, can include actions for calendaring information when the information is made publicly available. For example, if a user selects to have the application remind the user when Justin Bieber is scheduled to be shown in a movie, the application may update a calendar of the user with date and time information for a movie having Justin Bieber appear in the movie. In another example, the user may select to know when Justin Bieber is in concert in a particular location. When information related to Justin Bieber having a concert at the particular location is made available, the central computer system 1105 can find the information and update the user's calendar with date and time information of the concert.

Referring to FIG. 11B, a block diagram of the system 1100 showing components of the central computer system 1105 is illustrated.

In one embodiment, the central computer system 1105 can include, but is not limited to, a first federation server 1150, a data analyzer 1155, a data logger 1160, a decision data logger 1165, a decision controller 1170, an action data logger 1175, an action controller 1180, a second federation server 1185, a third party data feeder 1190, and a third party controller 1195.

In a typical implementation, a user may create a directive with the user device 1115. The user device 1115 can send the user directive to the central computer system 1105 via the network 1110. The federation server 1150 may be implemented to verify that the user directive is acceptable and allow the user directive to continue to the data analyzer 1155. The data analyzer 1155 can be implemented to analyze the user directive for the unique user identifier and a subject matter of the user directive. After the data analyzer 1155 has analyzed the user directive, the user directive can be logged and saved by the data logger 1160. For instance, the user directive can be stored in the database 170. The user directive can then be sent to the decision data logger 1165 before being sent to the decision controller 1170. The decision controller 1170 can include the previously mentioned application or matching software for making a determination if information related to the subject matter of the user directive is available. Depending on whether the decision controller 1170 determines if there is a marketing object related to the user directive, the decision controller 1170 can include an action to be taken by the central computer system 1105 in response to the user directive. For instance, the decision controller 1170 may determine a marketing object is available for the user directive and include an action to send the marketing object to the user. The action can then be sent to the decision data logger 1165 where the central computer system 1105 stores data related to the decision of the action and sends the action to the action data logger 1175. The central computer system 1175 can store the action via the action data logger 1175 to keep a history of actions taken by the system 1105. The action can then be sent to the action controller 1180 to be completed. For instance, the action controller 1180 may retrieve the marketing object and send the marketing object to the user device 1115.

To verify information and marketing objects coming from the third party sources 1120-1135, the central computer system 1105 can include the second federation server 1185, the third party controller 1195, and the third party data feeder 1190. As can be appreciated, the first federation server 1150 and the second federation server 1185 may be one of the same, or both may include a plurality of servers making up the federation servers. Data sent from one of the sources 1120-1135 can be first sent to the second federation server 1185. The second federation server 1185 may authenticate a source of the data before sending the data to the third party controller 1195. The third party controller 1195 can include an application, logic, and/or software to determine where the data from the third party providers should be stored. In some instances, the data can be stored in the third party data feeder 1190. As can be appreciated, the third party data feeder 1190 may be stored in the database 170. Marketing objects may be retrieved from the third party data feeder 1190 by the application and sent to the user device 1115.

The directives application, which can interact with the database 170 including aggregated data from the one or more portals 1120, the one or more synchronization databases 1125, the one or more crawlers 1130, and the one or more data feeds 1135 can allow consumers, users, etc. to be notified as their wants and needs, in real-time, become public knowledge from a particular source. For instance, time sensitive events can automatically be scheduled and calendared for a particular user as the events or conditions created by the user are made public knowledge. Typically, the directives application can be constantly reading and analyzing directives created by consumers, users, and companies and pulling related information from the one or more sources 1120-1135 as the information is made public knowledge and directing the information to the right user that matches certain criteria. In some instances, the information can be sent privately without going public.

In one embodiment, directives and/or marketing objects that are sent to a user can include one or more actions or controls to create more directives or commands based on the originating directive or marketing object. Typically, these additional actions, commands, or directives can always be active until canceled.

In one example, a user may create an initial directive to follow a particular movie and then may create another directive, based on the initial directive, to find out when that movie will be shown on television. Networks may see the aggregation of demands from the users of something specific, for instance, a large number of user requesting a particular movie. Once the aggregation of demands reach a certain number, one of the networks can decide to show the movie on a certain date and at a certain time. Once information from the network is made public knowledge, or when the network decides to release the information, all users that selected the system to follow that movie on television, will be notified immediately and the system generated calendar and scheduler will populate the users' calendars with the advertisement of the upcoming movie. For example, the network may have a network portal accessibly by the system. The system while performing a web crawl for new data, may find that the network portal includes data related to when a particular movie will be aired on television. Based on finding the new data, the system can determine which users have requested information about the movie and push that information to those users who previously submitted a directive to be informed when said movie would be aired on television. As can be appreciated, the system would automatically search for the information based on the user creating the directive and not stop searching until the data was found or the user canceled the directive. Some example actions or directives that may be created by a user include, but are not limited to, “Let me know when this movie is on television;” “Let me know when this movie is on rental;” and “Follow a certain celebrity of this movie.”

In one example, if the user is watching a talk show, and the talk show has several celebrities appearing on the show, the user can ask the system via voice command to see what the celebrities are wearing during that particular talk show. The system can then determine if the information is available, and if the information is available, the system may pull exactly what the celebrities are wearing and display the clothing for the user. In one instance, the user may select a fashion calendar to see what the celebrities are wearing. The system may also display how much each of the clothing items cost and where the items may be purchased.

In one example, the system can allow fashion designers to add products (e.g., as marketing objects) to the system via a portal and allow the fashion designers to have access to a celebrity database to select a celebrity and select clothing from their inventory that the particular celebrity will be wearing and then link the select clothing to the system. As can be appreciated, the celebrities can also have access to the designers. The designers can show celebrities via the system the clothing or fashion selection they may want to wear on television or in person at an event. They can concur on an ensemble from the fashion designers clothing and the system can create a marketing object and send the marketing object to all users who requested information on the celebrity, the fashion designer, and on the network show.

In one example, the designer, the celebrity, and the network can each have a portal connected to the system. The celebrity can tell the designer what show the celebrity will be appearing on as soon as the celebrity confirms it with a network. The designer may then compete with other designers for that celebrity to wear their clothing. The designer and the celebrity can both link to the network and show in which the celebrity and the clothes will be appearing. The system can create a marketing object including a date and a time the show will air, a date and time the celebrity will appear on the show, and information about the designer and the designer clothes. The system can automatically link and sync retail information to each product or fashion item selected, so the user can know exactly which retailers are carrying or selling the products, how much the products cost, how far away a nearest retail location to purchase is, and any other detailed information about the product(s).

Described hereinafter are several examples of things that can be synchronized or linked to a user on command related to the entertainment industry after a user, consumer, etc. has created a directive or command. Celebrities, celebrity clothing worn live on television, celebrity whereabouts on television, magazines, events, or anywhere else, movies, music, genres of movies, genres of music, live bands, etc. Locations of events, locations of celebrities, movies, shows, game shows, and specific years and episodes of shows that can all be shown on television can be linked or synchronized on command. Concerts, or any other form of entertainment and detailed information related to the concert or other form of entertainment can be linked to the user on command. Detailed retail information or any other industry information can be linked to the user on command.

Described hereinafter, is one example of a future directive being created and how the system may handle the future directive. In this example, Justin Bieber is going to be on ABC talking about his new album that is releasing soon. A user may initiate a future directive by commanding the system to notify the user anytime Justin Bieber will be on television, to notify the user when Justin Bieber's new album is released, and to purchase the album from Spotify for the user when the album is released. Each of the requests or commands can be generated as a future directive by the system. As can be appreciated, if the subject of the future directive is available, the system may update the user's calendar with available information when the directive is created.

As soon as a TV network announces to the public that Justin Bieber is going to be on a show on their network (e.g., ABC at 9:00 p.m. on Nov. 16, 2017), the network can send out information available to the system, which may receive the information and update each user that had requested information for Justin Bieber and television appearances. As can be appreciated, once the record company (e.g., Warner Brothers) releases information for the release date of the new album, the system can receive the information and update the calendar of each user requesting information for Justin Bieber's album release date.

In one example, while a user is watching the show, the user may become interested in clothing that Justin Bieber is wearing. The user may initiate a directive to the system to send the user product information on what Justin Bieber is wearing. Based on the directive, the system may provide product information on the brand being worn by Justin Bieber, for instance Gucci. The information can include where to buy the product Gucci, a cost for the outfit, and a distance to a store that sells the clothing.

As can be appreciated, ABC, Warner Brothers, Gucci, retailers selling the Gucci products Justin Bieber is wearing, Justin Bieber's Publicist, and the user will all have a portal, created by the central computer system 1105, which can be linked or synchronized with the central computer system 1105. The central computer system 1105 system can be synchronized with all systems.

In one instance, once the TV network and Justin Bieber announce that they are going to introduce the album release to the world, marketing directives about the event can be sent to the TV network, the record company, and Justin Bieber. Of note, each of the entities may send the marketing directives to each other. The system can ensure that the record company, Justin Bieber, and the TV network can all send out marketing directives to all the people following Justin Bieber. In one instance, the TV network may send out a directive to the designer (e.g., Gucci) and the retailer about the time and date of the event. The designer and the retailer may send out directives to the TV network requesting automatic time and date times of the event, and the designer may send out marketing object directives to Justin Bieber about their clothes and shoes the designer wishes for him to wear on the show. In one example, once Justin Bieber agrees to wear the clothes from the designer, product information for the clothing by the designer that Justin will be wearing will be sent to the Fashion Calendar and the TM-Slide system to be displayed to the user on demand. The user's directives can direct the system to go get the requested information, and if not there, the directive will continue to search or remain active until the requested information may come into existence or made public knowledge for the very first time. Once the system can recognize that the requested information exists, the system may send the request or directive to the source to synchronize bi-directional matching between the user and the source of information. For example, the system may match and synchronize all sources scheduling Justin Bieber related events and the calendar will be scheduled with all related advertising and product information. Also, the system may purchase the album for the user and send a receipt to an entertainment calendar.

Described hereinafter is another example implementation of an embodiment of the present invention. A user can tell the system, manually or through voice command, to wait on a condition to exist and then perform an action or multiple actions. For instance, the user may wish to have the system initiate one or more actions based on a condition occurring. The user may request one or more actions based on the user traveling via an airplane from one location to another location. In this example, the user is traveling from Denver to New York. The system can automatically be told after the user purchases a ticket on the universal system to automatically purchase, download, and/or add movies to a playlist on a device of the user. For instance, the movies may be favorites previously selected by the user or the system can download movies based on prior purchase and/or streaming history of the user. The system may also be told the same day as the ticket was purchased to add movies to the user's playlist. Typically, the system can automatically notify the action(s) in the user's calendar that links to one or more others events in the calendar. For instance, buying a plane ticket can be linked and synced to automatically adding movies to the user's playlist.

The system can automatically perform actions once conditions have been satisfied. For instance, the system may present information to a user when the information becomes public knowledge for a first time. In one example, the system can automatically add movies to a user's device after the user buys a ticket. The system may also schedule any schedulable actions in the calendar. As can be appreciated, once conditions are set by the user, everything can become system generated. For instance, the system can link and sync the user to the condition, product, service, source, brand etc.

The user can also tell the system to perform an action or multiple actions based on pre-dated condition change, futuristic condition, or a forecasted condition. The system can perform an action or duties until an expired date selected by the user. In one example, if a woman is pregnant, she can tell the system to alert companies that she is pregnant. More specifically, the system can alert companies that sell newborn related products that the user will be having a baby boy, and prepare a baby registry for products systematically sent by companies related to pregnant women and baby boys. Companies may have a portal through the system that will automatically send coupons, discounts, and/or advertisements of products or services related to pregnant women and baby boys. Products related to preferred discounts can be requested by the user or pregnant women to receive product information that meets her discount criteria.

The system all works the same in different variations to all participants to receive system generated necessary information. All sources may be connected. For instance, one company's or consumer's directive, command, request, event, product, and/or condition change can trigger another company or consumer to initiate directives, commands or requests to another company or consumer. The creation of new directives and/or commands based on previously created directives and commands can be done simultaneously.

### Calendaring

In one embodiment, a calendar application 102 of the system can include a visual user interface. In addition to the visual user interface, implementations provide an application programming interface (API) 110, which enables the calendar application 102 to interact with other programs (standard or custom). In some implementations, the calendar application can interact with a trigger event daemon 112 through the API 110, as described in more detail below. The trigger event daemon 112 may also receive sensor signals 154 from various client device sensors 114 (e.g., sensors included with a Smart phone) and/or from other home sensors 124. Implementations typically store calendar data 106 and event data 108 in a database 104. Data can be sent to and received from the calendar application 102 and the calendar API 110. In some implementations, the database 104 can be a relational database, such as an SQL database. In other implementations, the database 104 can be structured data stored as files on a file server. Some implementations include two or more databases. The database 104 may be stored as a CSV file, an XML file, a flat file, or in other formats.

A system according to principles of the invention may read from, write to, and modify, via the web, calendar data for calendar (e.g., Google Calendar) services that provide external access to data and functionality through an API (e.g., the Google Data Protocol). Thus, for example, a user's calendar may be updated to indicate when a pending aggregate directive expires, the date(s) and time(s) for fulfillment of an aggregate directive accepted by a supplier, and reminders for approaching deadlines. Calendared data may include text, graphics, any of which may comprise hyperlinks to other text, graphics, audio and/or video data, files or streams.

The conditions may include, for example, location, temporal and/or financial terms. If a starter of a car is going bad, the starter will trigger a response to the manufacturer, the retailers that carry the product, the service departments of automobile dealerships, and the consumer. The consumer is notified via calendar the date and time the starter sends the initial response and notified with the date and time the starter is expected to expire or die out. The retailer or automobile service department is simultaneously triggered from the response of the starter. The retailer or service department's calendar and scheduling system is automatically receiving data from the consumer, the consumer's calendar, the consumer's car, and the consumer's starter about the expiration date of product and then replies back to the consumer with available times and dates in which they can do the service or replace the product. The consumer's calendar is triggered and updated with multiple retailers and automobile service department's available times and dates requesting the consumer's services. The consumer, via calendar, can the decided on which dates and times is best for them and send a confirmation via calendar and then system will automatically schedule the appointment for both. Scheduling is automatically between the consumer and retailer or service department in consumer or product driven calendar. The calendar can also work from business to business between manufacturer and retailers or service departments.

Calendaring may entail generating a calendar file (e.g., .ics file) with date and aggregate demand information (which may include hyperlinks). The calendar file is sent to a user's calendar application for importing. Alternatively, a system according to principles of the invention may read from, write to, and modify, via the web, calendar data for calendar (e.g., Google Calendar) services that provide external access to data and functionality through an API (e.g., the Google Data Protocol). Thus, for example, a user's calendar may be updated to indicate when a pending aggregate directive expires, the date(s) and time(s) for fulfillment of an aggregate directive accepted by a supplier, and reminders for approaching deadlines.

The computer chip or remote on the devices will trigger the calendar and scheduling system in the IoT invention. The specific directive may search for a product, service, or entertainment information requested by the user that doesn't currently exist and then remains active until such information or change of condition becomes publicly or privately available. Once the information or change is available, the user's calendar is triggered and notified with the requested information, and the advertising reflecting change, product or service information is displayed. A specific directive may come with a good faith cost or deposit for purchase of goods, services, and entertainment or product conditions that doesn't currently exist. Once the deposit is made, the user is guaranteeing the purchase of the product, service, or entertainment if the condition is changed or met and the product or service is also guaranteed to the user by the supplier. When condition is met, the user is notified via calendar. If the user, after deposit, decides not to buy the product or service, then the deposit is retained or not refunded.

A user's calendar may be updated with a notification. This is especially useful for time constrained notifications, such as notifications of conditions that will exist for a limited time (e.g., sales, live performances, coupons with expiration dates). Illustratively, an .ics iCalendar file or other compatible calendar file or data stream may be sent (e.g. pushed) to a user's calendar app on the user's client computing device 120, 125, 135-150 to populate the local calendar with the date-related and/or time-related notification information. The process may be automated, requiring no user intervention. The process may be chronologically synchronized using auto-datafeeds.

The calendar app will generate a reminder notification as the scheduled date and time approaches. Such scheduling provides further assurance of consumer participation, while also providing users a reminder.

A computer network enabled calendaring method according to principles of the invention operates using a computer system with one or more computers and network (e.g., Internet) connectivity. The computer system receives via the network, a first directive. The first directive includes first directive data, which includes a first subject matter and a first user identification. The first subject matter expresses a first interest. By way of example, a user may create a directive expressing interest in a performer, or a brand, or a retailer, or a television program, or a product or a service or something else. The computer system enters the first directive data in at least one database on the computer system.

The computer system receives, via the computer network, a second directive, which includes second directive data. The second directive data includes a second subject matter responsive to the first interest and a second time associated with the second subject matter. The computer system determines if the second directive includes second subject matter responsive to the first interest. The computer system enters the second directive data in a database on the computer system. Illustratively, the second directive may offer to sell tickets to a performance, or offer goods of a particular brand, or provide information about a sale at a retailer, or provide information about a television program, or offer a particular product or service or something else in response to the first directive.

The computer system adds a first event to first calendar data for a first calendar associated with the first user identification. The first event identifies the second subject matter and includes the second time. The addition is accomplished by sending the data for the event to the address for the calendar application in accordance with an API for the calendar application. Thus, for example, the first user's calendar data is updated with a new event for the second directive.

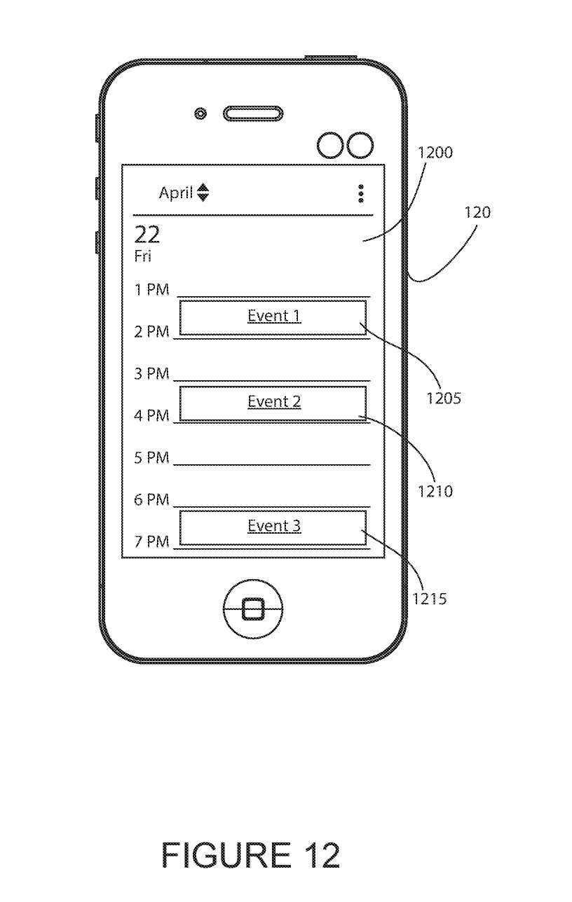

Referring to FIG. 12, an exemplary calendar 1200 for a user is displayed on a mobile device 120. One or more events 1205-1215 are displayed in corresponding time slots. The events may be links to other objects, such as web pages, video streams, text, audio streams, etc.

In another embodiment, a user's calendar can be presented, generated or updated with information relating to a particular day or time. For example, information responsive to a user's preferences and conditions may be displayed on a calendar. Such information may include discounts and special savings available at particular retailers, celebrity appearances and performances, concerts and sporting events, etc. Such calendar information may be displayed on a calendar generated using the system and/or displayed on a user's calendar via a compatible calendar file. Illustratively, an .ics iCalendar file may be sent to users to populate their local calendars with the date-related information.

A handheld mobile electronic device such as a mobile phone or tablet may be equipped with an electronic calendar application or widget. Generally, a user may plan events on certain dates of a month or a year using the calendar as well as activities within a single date. In other words, a user may customize one's own calendar by entering information to annotate a certain date or a certain time of the day. An exemplary system and method of the present invention performs the steps of synchronizing the mobile calendar with the system's calendar data storage to generate a synchronized data. Periodically or upon user instruction, the online calendar data is downloaded from the system into the mobile device in a format compatible with the mobile device calendar application or widget, and then is integrated into the database of the calendar application/widget.

In one embodiment, calendared events may be displayed on a mobile device by side swiping motion. For example, a series of events (e.g., events for the day, week, two weeks, month or some other time period) may be displayed in chronological order in a side to side swiping list. Thus, a user may swipe (i.e., manually input an instruction to advance) to progress through the series of events on the calendar.

Advertising and Marketing Data Pool and Calendar Chronological Synchronization is also enabled. A data pool of products and services information may be synchronized to the user or customer's calendar and universal centralized consumer driven remote for real-time and accurate advertising and information for viewing and buying purposes. The system may synchronize advertising logo, brand, and consumer-driven information in chronological order displaying accessible in a pictogram. Various items may be displayed in a swiping chronological order for the date advertising or marketing is selected. The calendar may display a number of options including the channel of specific shows on television or radio or new sale pricing or viewing information from advertisers.

### System Aggregation and Generation of Directives

Embodiments of the system can further include an application or program dedicated to aggregating and generating directives based on previously created directives. The application can be configured to initiate self-generated bi-directional directives or commands based on predictive analysis. The application can deliver, receive, and/or initiate recommendations or results based on information obtained from directives including, but not limited to, personal, family, and business information and information from products, services, entertainment options, data analytics, likes, preferences, necessities, habits, location, and past, present, and foreseeable activities from both the consumer and the company without any user intervention. Recommendations and results can also come from demand aggregation.

Application generated directives may list results or recommendations based on predictive analytics. For example, the application may make recommendations based on what is popular in a particular area, city, state, nation, or worldwide. The application can list popular products, services, entertainment options, restaurants, roses, places to go, places to see, events to see, genres etc. In one instance, recommendations or results may come from a linked user's (e.g., family member) personal likes, habits, favorites, etc. As can be appreciated, the user may respond back to the application for additional or different options. For instance, the user may select other actions or links that are connected to the recommendation or be connected to a purchasing like for that particular product or service. The application can be connected to the calendaring system for input, scheduling, notifying, or reminding in a user's calendar. The application may also tell a user where to go to get a product or service once the user accesses a link provided by the application based on the user's input.

In one embodiment, a user may connect one or more user IDs together. For instance, an entire family or important friends' links or ID's can be connected together. In one example, the application may provide an area or page at sign-up to add friends or family's personal information. Based on this information, the application can automatically generate reminders and recommendations on things they may like or want to do on special days or events.

In one embodiment, the system can be implemented to provide charitable contributions to one or more users. For example, a user may request products and/or services through a directive or forecasted directive creating one or more actions through a voice command or a manual input to deliver time sensitive results for when the user may need them. In some instances, these deliverable results may come from habits, likes, and/or from personal and business calendars. In one instance, each action may be picked up from different advertisers, brands, or other people on the system to pay for the product or service as needed for the user seeking charitable contributions.

In one embodiment, the system can implemented to allow users to aggregate rewards to use for charitable contributions. For example, the users can share on a gift card or rewards card adding money for a gift limit. In one example, if the system knows a user's birthday, the user's child's birthday, anniversary, or any other personal information, the system can systematically initiate an action, directive, or command and through multi-directional predictive analysis automatically issue a credit card, gift card, or reward card and aggregate demand for other people on the system (or the company, or brands themselves) to donate money to the gift card for the user to purchase a gift for their child. As can be appreciated, companies on the system may also send gifts.

The system can automatically generate things that the child may like based on habits, likes, and favorites through multi-directional predictive analysis or directives and display these products for the user to view on the interface and then the user can choose the product he or she wants for their child. Donors or charitable contributors who want to provide for the user can be notified systematically about the user's needs or family members needs or personal or business special events from their city or state, specific needs, specific special events, birthday months, specific stores, or on demand. The system can be implemented to learn habits, favorites, likes, past, present, and foreseeable events. As can be appreciate, the user may add their birthday, anniversary day, graduation day, etc. . . . even for their children and family. Once an important date comes up, the system will automatically issue gifts based on habits, likes, directives, etc.

In one embodiment, the system can be implemented to self-generate directives based off of a first directive. For example, a user may request the system to find women that have children between the age of 3 and 12 and that have expressed an interest in the circus. Based on the directive, the system can trigger other directives from other companies that are following a particular circus company and send those directives or request to another company or initiate predictive analysis leading up to a day the circus will be performing.

In one embodiment, the system can read or understand your resting and traveling locations and recommend products or services related to the locations you are traveling to or are currently at. The system may also recommend non-locational products or services that may be related to the location or product or services of a particular location.

In one embodiment, the system can read a user's personal or business calendar or recognize purchases and can proactively prepare recommendations, reminders, or results from entertainment options, daily schedule, or plan multiple activities or events or appointments or knowhow around the user's plans that are available in the user's calendar.

### Consumer Based Advertising System and Method(s) of Use

Embodiments of a consumer based advertising system and method can allow consumers of fashionable products to market and advertise products they purchase by wearing the products and allowing other consumers to search product information, review product information, and purchase the same products worn after seeing the consumer wear the products. In one embodiment, the consumer based advertising system can be implemented within the previously mentioned system 1100.

In one instance, a consumer advertiser may pay for products based how many searches, purchases, or views are made based on other consumers searching for the products after seeing the consumer advertiser wearing the products. For example, a designer may indicate to consumer advertisers that they will be reimbursed for their purchase based on the consumer advertiser getting a predetermined number of searches, views, purchases or combinations thereof of a particular product.

In one instance, consumer advertisers may be monetarily compensated based on the number of people viewing the fashionable products worn by consumer advertiser and purchased from a marketing page linked to the consumer advertiser or the retailer's site.

As the consumer advertiser purchases more products, the purchased products can be saved to a consumer advertiser inventory page and can be available to other consumers as the consumer advertiser wears the new products. The fashionable products themselves can be loaded into central computer system 1105 by a data feed from a source of the product or from a designer portal page to load their products into the central computer system 1105. All products being displayed via the consumer advertiser application can be displayed by the Slidebuy system. In one instance, users may have their own styling page to display their styles and each product showcased may have an individual link to display price, product information, and/or images of that particular product in the SlideBuy system.

In one embodiment, the consumer based advertising system can privately record a geographical location (e.g., via GPS signal) of where the consumer advertiser is displaying products. In one instance, the location data can give any other consumer looking to purchase the fashionable product an opportunity to remember where that consumer advertiser was located when they had noticed the product. For example, if a first user saw a consumer advertiser with a nice pair of boots that the user first user would like to purchase for their daughter, the first user may hit an activation button that triggers a GPS system of a user device to determine a current location of the first user. The system 1100 could then trigger all consumer advertisers' GPS locations in a vicinity of the first user who are currently advertising the clothing (or products) they are wearing. The first user could then search through each of the consumer advertisers located within a prescribed distance from the first user to find the consumer advertiser who is wearing the product the first user likes. The first user may then ask the system 1100 to remember the consumer advertiser's username so that the first user can visit the consumer advertiser's webpage to obtain a link to the particular product.

In another instance, the first user may remember a particular product at a later time after they have left a geographical location of where they saw the product. The first user could request the system 1100 to display all of the consumer advertisers a particular area at a particular time to search through consumer advertisers that were at that location at the requested time.

In one embodiment, the activation button that triggers the GPS system and the consumer advertisers' products could display all styles from different advertisers and then the consumer may select a particular product to display in the Slidebuy application or choose an all button to display all of the products worn that particular day in the Slidebuy application.

As can be appreciated, all of a consumer advertiser's products can be linked to a consumer who has searched for the consumer advertiser's products looking to purchase the fashion products. In one example, once the consumer has clicked on or searched for the products, the consumer advertiser can be credited for 60 days or earn money from that particular potential buyer up to 60 days if that consumer ends up buying a product linked to the consumer advertiser.

In one embodiment, to enhance a privacy of the consumer advertisers, consumers must activate the GPS system and the GPS system of all consumer advertisers in an area when the consumer is actually in the area.

Embodiments of the consumer based advertiser method and system allow a consumer to advertise and earn revenue from products they purchase. The method and system can allow the consumer to advertise and earn revenue from products or clothes that they wear every day. The method and system allow the consumer to view and purchase products or fashion from everyday people. The method and system allow everyday consumers to have access or knowledge of product information including product name, designer, price, and retailer information of where the product is sold. The method and system allow consumers to trigger a GPS location to access their own location and a consumer advertiser in the network's current location of where the consumer first saw the products and to display consumer advertisers' current and past wearable product information and the retailer where to purchase the products. The method and system allow consumers to trigger a GPS system to access their current location to display and have access to all human advertisers and product and retailer information of their wearable products in a particular location. The method and system allow a network of people having access to view product information and purchase wearable products of other people in the network. The method and system allow a network of people having access to view product information and purchase wearable products of other people in the network using an affiliate program. The method and system allow a network of people having access to view product information and purchase wearable products of other people in the network by using a first or third party network to click on product links directly from the source. The method and system allow a use of human or consumer based advertisers as affiliates to promote products worn every day or any day. The method and system allow privately recording or tracking where the consumer-based advertiser is displaying or promoting the product and where the product is located all day for instant product information triggered by the consumer looking to purchase the wearable products. The method and system allow a consumer to click on a particular fashionable product worn by a consumer advertiser on the picture and displaying the clicked products information.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A method for presenting information to a user on a user device, the method comprising steps of:
providing a system, the system including:
a central computer system;
a database accessible by the central computer system, the database storing a plurality of marketing objects;
at least one data feed connected to the central computer system, the at least one data feed populating the database with a first set of the plurality of marketing objects;
at least one portal having a portal database accessible by the central computer system, the portal database including a second set of the plurality of marketing objects;
at least one synchronizing database including a third set of the plurality of marketing objects, the synchronizing database syncing the third set of marketing objects with the database; and
at least one crawler adapted to populate the database with data to generate one more marketing objects;
wherein each of the plurality of marketing objects includes a marketing subject matter;
the central computer system receiving a first user directive, the first user directive including a user identification and a user subject matter;
the central computer system determining if the user subject matter matches with a marketing subject matter from one of the plurality of marketing objects;
if one of the marketing subject matters matches with the user subject matter, the central computer system sending the matching marketing object to a user device;
the user device displaying a graphical representation of the marketing object on a display of the user device.

2. The method of claim 1, wherein the user inputs the first user directive by a voice command on the user device.

3. The method of claim 1, further comprising the steps of:
if none of the marketing subject matters match with the user subject matter, the central computer system performing the following steps:
checking the at least one data feed for data related to the user subject matter;
checking the at least one portal for data related to the user subject matter;
checking the synchronized database for data related to the user subject matter; and
checking data retrieved by the crawler for data related to the user subject matter.

4. The method of claim 3, the central computer system further performing the steps of:
finding data related to the user subject matter;
creating a marketing object including data related to the user subject matter; and
sending the created marketing object to the user device.

5. The method of claim 1, wherein the plurality of marketing objects include subject matter related to entertainment.

6. The method of claim 5, wherein the marketing subject matter is selected from the group consisting of musicians, actors, actresses, athletes, sporting events, bands, music artists, comedians, and entertainers.

7. The method of claim 1, wherein the computer system repeatedly checks data from the one or more data feeds, the one or more portals, the synchronized database, and the crawler until data related to the user subject matter has been found.

8. The method of claim 1, wherein the user directive further includes one or more instructions to perform an action based on the user device receiving the matching marketing object.

9. The method of claim 8, wherein the user device is adapted to perform the one or more actions when the user device receives the matching marketing object from the computer system.

10. A method for obtaining data, the method comprising the steps of:
receiving a user directive, the user directive including a unique user identifier, a user subject matter, and an action;
determining if one of a plurality of available marketing objects matches with the user subject matter from a marketing object database;
if one of the plurality of available marketing objects match with the user subject matter, sending the matching marketing object to the user;
if none of the plurality of available marketing objects match with the user subject matter, performing the following steps:
checking a plurality of data feeds for data related to the user subject matter;
checking data accessible via one or more portals for data related to the user subject matter;
checking data from a synchronized database for data related to the user subject matter;
checking data retrieved by a web crawler not stored in the marketing object database for data related to the user subject matter;
finding data related to the user subject matter;
creating a marketing object including data related to the user subject matter; and
sending the created marketing object to the user.

11. The method of claim 10, further comprising the step of:
sending the created marketing object to each user having generated a directive with a subject matter related to the created marketing object.

12. The method of claim 10, further comprising the step of:
performing the action based on matching a marketing object with the user subject matter.

13. The method of claim 12, wherein the action includes calendaring the marketing object in a calendar of the user.

14. The method of claim 12, wherein the action includes downloading a movie based on the matched marketing object to a device of the user.

15. The method of claim 12, wherein the action includes providing a retail location selling a product related to the matched marketing object.

16. The method of claim 10, wherein the computer system repeatedly checks data from the one or more data feeds, the one or more portals, the synchronized database, and the web crawler until data related to the user subject matter has been found.

17. The method of claim 10, wherein the plurality of data feeds are from a first set of retailers.

18. The method of claim 17, wherein the one or more portals are from a second set of retailers.

19. The method of claim 18, wherein the synchronized database is from a third set of retailers.

20. A system for obtaining data, the system comprising:
at least one processor;
at least one computer-readable storage media having stored thereon computer-executable instructions that, when executed by the at least one processor, causes the system to perform a method, the method comprising the following:
receiving a user directive, the user directive including a unique user identifier, a user subject matter, and an action;
determining if one of a plurality of available marketing objects matches with the user subject matter from a marketing object database;
if one of the plurality of available marketing objects match with the user subject matter, sending the matching marketing object to the user;
if none of the plurality of available marketing objects match with the user subject matter, performing the following steps:
checking a plurality of data feeds for data related to the user subject matter;
checking data accessible via one or more portals for data related to the user subject matter;
checking data from a synchronized database for data related to the user subject matter;
checking data retrieved by a web crawler not stored in the marketing object database for data related to the user subject matter;
finding data related to the user subject matter;
creating a marketing object including data related to the user subject matter; and
sending the created marketing object to the user.
